(19) United States
(12) Patent Application Publication
(10) Pub. No.: US 2025/0245564 A1
(43) Pub. Date: Jul. 31, 2025

(54) SYSTEM AND METHOD FOR MODEL TRAINING IN DECENTRALIZED COMPUTING ENVIRONMENTS

(71) Applicant: R-STEALTH LTD, Givat Shmuel (IL)

(72) Inventors: Ben BOREN, Givat Shmuel (IL); Harel BOREN, Givat Shmuel (IL)

(73) Assignee: R-STEALTH LTD, Givat Shmuel (IL)

(21) Appl. No.: 18/853,243

(22) PCT Filed: Apr. 4, 2023
(86) PCT No.: PCT/IL2023/050375

§ 371 Date: Oct. 1, 2024

Related U.S. Application Data
(60) Provisional application No. 63/326,938, filed on Apr. 4, 2022.

(51) Int. Cl. G06N 20/00

(52) U.S. Cl. CPC G06N 20/00

(57) ABSTRACT

A computer based system and method for providing decentralized training of a machine learning model, including: obtaining a mini-task of training the machine learning model wherein the mini-task comprises at least one mini-batch size; obtaining an estimation of at least one performance indicator in each trainer of a plurality of trainers that have available computing power, wherein each trainer comprises one or more processors; calculating a maximal micro-batch size for each processor of the plurality of trainers based on the at least one performance indicator of the respective trainer, and parameters of the mini-task; and assigning the mini-task to at least one designated trainer of the plurality of trainers based on the maximal micro-batch sizes of the one or more processors of the at least one designated trainer and the at least one mini-batch size.

### FIELD OF THE INVENTION

The invention relates generally to a method for automatically providing decentralized computing resources for performing highly intensive computing tasks related to machine learning models including training of deep learning models, neural architecture search processes, and hyperparameter tuning processes.

### BACKGROUND OF THE INVENTION

Artificial intelligence (AI) and machine learning (ML) models such as neural network (NN) models, are gaining increasing popularity. Applications of ML models are spread in nearly every professional field, including financing, automatic vehicles, linguistics, health services, digital media, advertising and many others. Developing an ML model to a production level of being implemented and used in a product or a service, typically includes model creation, generation of datasets for training and validation, including in many cases data accumulation and labeling, model training, architecture search, and hyperparameter optimization of the model.

An ML lifespan may be generally divided into training and inference phases. Training may include creating the ML model and training the ML model by running a training dataset into the ML model to adjust the model parameters and weights. Inference may refer to using the ML model on real life input data to produce predictions based on the input data.

Training of ML models and hyperparameter optimization, as well as ML model inference is a computationally intensive task. Generating a satisfactory ML model typically requires building many test models, training each of the test models using training and validation datasets, improving the test models, and retraining them in an iterative process of optimization, to achieve a final model (e.g., the production or production-grade model) that provides predictions at satisfactory performance.

ML models may include millions, or even tens and hundreds of millions, of trainable parameters, and training an ML model may require hundreds of millions or billions of computations per each run of the model on the training dataset (epoch), where training typically includes tens to several hundred of epochs. In addition, an ML model may require further maintenance after being put to production due to data drift, e.g., changes of the distribution of production data over time. Maintenance may include retraining, optimization of hyperparameters and/or adjustments of the model itself. Therefore, the amount of computing power used to train ML models constantly increases, making ML adoption in both the development and production phases both environmentally unfriendly and expensive.

Training of ML models may be performed using on-premises computing power or using a cloud service. Cloud computing services may provide large and scalable computing power. However, cloud computing requires lengthy and complex setup procedures and are expensive. Therefore, other ways for providing the computing power are required for performing training, optimization, and production phase inference and maintenance of ML models, that are less complex, less lengthy, less expensive, more accessible and generate a lesser carbon footprint are needed.

### SUMMARY OF THE INVENTION

According to embodiments of the invention, a computer-based system and method for providing a decentralized training of a machine learning model, the method may include, using a main processor: obtaining a mini-task of training the machine learning model wherein the mini-task comprises at least one mini-batch size; obtaining an estimation of at least one performance indicator in each trainer of a plurality of trainers that have available computing power, wherein each trainer comprises one or more processors; calculating a maximal micro-batch size for each processor of the plurality of trainers based on the at least one performance indicator of the respective trainer, and parameters of the mini-task; and assigning the mini-task to at least one designated trainer of the plurality of trainers based on the maximal micro-batch sizes of the one or more processors of the at least one designated trainer and the at least one mini-batch size.

According to embodiments of the invention, assigning the mini-task to the at least one designated trainer may include instructing each designated trainer of the at least one designated trainers to calculate model weights using mini-batches or gradients using micro-batches.

According to embodiments of the invention, assigning the mini-task to the at least one designated trainer may include logically dividing the mini-task into a plurality of mini-task portions, and assigning each mini-task portion of the plurality of mini-task portions to a respective designated trainer of the plurality of designated trainers, wherein each mini-task portion of the plurality of mini-task portions may include a micro-batch size that is not larger than the maximal micro-batch size of the respective one or more processors of the designated trainer, wherein assigning a mini-task portion to a respective designated trainer may include instructing the respective designated trainer to calculate gradients with the respective micro-batch size.

Embodiments of the invention may include, obtaining gradients calculated by each of the at least one designated trainer; accumulating the gradients over the mini-batch; and updating weights of the machine learning model using the gradients.

Embodiments of the invention may include, assigning the mini-task or mini-task portion to a first designated trainer of the at least one designated trainer, where the first designated trainer includes a plurality of processors; logically dividing the mini-task or mini-task portion into a plurality of second-level mini-tasks and assigning each of the second-level mini-tasks to a respective processor of the plurality of processors, wherein each second-level mini-task of the plurality of second-level mini-tasks comprises a micro-batch size that is not larger than the maximal micro-batch size of the respective processor, wherein assigning each of the second-level mini-tasks to the respective processor may include instructing the respective processor to calculate gradients with micro-batches that have a size that equals the micro-batch size.

Embodiments of the invention may include, obtaining the mini-task or mini-task portion at a first designated trainer of the at least one designated trainer; monitoring, by the first designated trainer, at least one current performance indicator of the first designated trainer; determining a new maximal micro-batch size for the first designated trainer based on the at least one current performance indicator, and parameters of the mini-task or mini-task portion; logically dividing, by the first designated trainer, the mini-task or mini-task portion to a plurality of second-level mini-tasks, wherein each second-level mini-task of the plurality of second-level mini-tasks has a micro-batch size that is not larger than the new maximal micro-batch size; and executing the of second-level mini-tasks by calculating gradients with micro-batches that have a size that equals the new micro-batch size.

Embodiments of the invention may include, obtaining a reduction in the performance indicator in the first designated trainer, wherein the reduction makes the designated trainer uncapable for executing the second-level mini-task; and applying a gradient checkpointing in the first designated trainer.

According to embodiments of the invention, the performance indicators of a trainer may include at least one of: available memory space of each processor in the trainer, computing power of each processor in the trainer, total memory space of the processors in the trainer, frequency of past dynamic adjustments of the size of the micro-batch assigned to the trainer, specifications of each processor of the trainer and sample processing rate of each processor in the trainer, and the parameters of the task may include memory space required for training the machine learning model and memory space required for training a sample of the plurality of samples.

Embodiments of the invention may include, periodically monitoring the performance indicator of a first designated trainer of the at least one designated trainer to obtain a current performance indicator of the first designated trainer; and dynamically adjusting the size of the micro-batch assigned to the first designated trainer based on the current performance indicator.

Embodiments of the invention may include, obtaining a frequency of past dynamic adjustments of the size of the maximal micro-batch designated to the first designated trainer; wherein the mini-task may be assigned to the at least one designated trainer based on the frequency of past dynamic adjustments.

Embodiments of the invention may include, periodically monitoring a sample processing rate at a first designated trainer of the at least one designated trainer; and dynamically adjusting the size of the micro-batch designated to the first trainer based on the sample processing rate.

Embodiments of the invention may include, obtaining a change in the estimation of an available memory space in a first designated trainer of the at least one designated trainer; and dynamically adjusting the maximal micro-batch size of the first designated trainer based on the estimation of the available memory space.

According to embodiments of the invention, the mini-task may include a portion of a task gist extracted from a task of training of a machine learning model, wherein the task gist may include a model structure, model weights, datasets, and hyperparameters, and wherein the portion may include the model structure, the model weights, the datasets, and a subset of the hyperparameters, and wherein assigning the mini-task to the at least one designated trainer may include transferring the mini-task to the at least one designated trainer.

According to embodiments of the invention, the machine learning model is a neural network.

According to embodiments of the invention, the mini-task of training of the machine learning model comprises the model weights, hyperparameters and datasets.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 schematically illustrates a system, according to embodiments of the invention.

FIG. 2 schematically illustrates dataflow between a client, an orchestrator and a trainer, according to embodiments of the invention.

FIG. 3 schematically illustrates a system according to embodiments of the invention.

FIG. 4 schematically illustrates dataflow between a client, orchestrator, a trainer and a parameter server, according to embodiments of the invention.

FIG. 5 is a flowchart of a method providing decentralized computing resources for training an ML model, according to embodiments of the present invention.

FIG. 6 is a flowchart of a method providing decentralized computing resources for an ML model inference, according to embodiments of the present invention.

FIG. 7 is a schematic illustration of a system for providing decentralized computing resources, according to embodiments of the invention.

FIG. 8 is a schematic illustration of a system for providing decentralized computing resources, according to embodiments of the invention.

FIG. 9 is a schematic illustration of a system for providing decentralized computing resources, according to embodiments of the invention.

FIG. 10 is a schematic illustration of a system for providing decentralized computing resources, according to embodiments of the invention.

FIG. 11 is a schematic illustration of a system for providing decentralized computing resources, according to embodiments of the invention.

FIG. 12 which is a flowchart of a method for using gradient accumulation in system for training an ML model using decentralized computing resources, according to some embodiments of the present invention.

FIG. 13 illustrates an example computing device according to an embodiment of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

Although some embodiments of the invention are not limited in this regard, discussions utilizing terms such as, for example, “processing,” “computing,” “calculating,” “determining,” “establishing”, “analyzing”, “checking”, “inferring” or the like, may refer to operation(s) and/or process(es) of a computer, a computing platform, a computing system, or other electronic computing device that manipulates and/or transforms data represented as physical (e.g., electronic) quantities within the computer's registers and/or memories into other data similarly represented as physical quantities within the computer's registers and/or memories or other information transitory or non-transitory or processor-readable storage medium that may store instructions, which when executed by the processor, cause the processor to execute operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items unless otherwise stated. Unless explicitly stated, the method embodiments described herein are not constrained to a particular order or sequence. Additionally, some of the described method embodiments or elements thereof can occur or be performed in a different order from that described, simultaneously, at the same point in time, or concurrently.

Developing, running and maintaining ML models, and specifically NN models, have significant costs in terms of time, money, human resources, etc. Developing an ML model to a production level may take from between several weeks to months or years. For example, developing an ML model may include determining a model structure from a plurality of prospective model structures, training each of these models using an annotated or labeled training dataset (supervised learning) as well as training each of these models using non-annotated or unlabeled training dataset (unsupervised learning), until arriving at a final model that generates predictions with satisfactory performance. As known, performance of an ML model may be defined and measured in terms of any applicable metrics, including accuracy, precision and recall, etc. Each of these models may typically include millions, or even tens and hundreds of millions, of trainable parameters, and its each iteration of training may require hundreds of millions or billions of computations, per each epoch. Every model training-run usually includes tens to several hundred epochs to get to a model having satisfying performance.

Each task of training an ML model may also include hyperparameters that are used to define model and training characteristics, including, inter-alia, a learning rate, a mini-batch size, a loss function, a number of decision trees, max-depth, a number of epochs, etc. In some configurations, the specifications of the model architecture itself are hyperparameters, e.g., the number of convolution layers or the number of dense layers that make up a NN model may not be hard-coded, but rather a hyperparameter that is adjusted alongside other hyperparameters during iterative training sessions in search of the satisfactory model.

A NN may refer to an information processing paradigm that may include nodes, referred to as neurons, organized into layers, with links between the neurons. The links may transfer signals between neurons and may be associated with weights. A NN may be configured or trained for a specific task, e.g., pattern recognition or classification. Training a NN for the specific task may involve adjusting these weights based on examples (e.g., labeled data included in the training dataset). Each neuron of an intermediate or last layer may receive an input signal, e.g., a weighted sum of output signals from other neurons, and may process the input signal using a linear and/or nonlinear function (e.g., an activation function). The results of the input and intermediate layers may be transferred to other neurons and the results of the output layer may be provided as the output of the NN. For example, in a NN algorithm known as the gradient descent algorithm, the results of the output layer may be compared to the labels of the samples in the training dataset, and a loss or cost function (such as the root-mean-square error) may be used to calculate a difference between the results of the output layer and the labels. The weights of some of the neurons may be adjusted using the calculated differences, in a process that iteratively minimizes the loss or cost until satisfactory metrics are achieved or satisfied. A NN may be executed and represented as formulas or relationships among nodes or neurons, such that the neurons, nodes or links are “virtual”, represented by software and formulas and mathematical constructs, such as activation functions and multi-dimensional matrices of data elements and weights. A processor, e.g., central processing units (CPU), graphical processing units or fractional graphical processing units (GPU) or tensor processing units (TPU) or a dedicated hardware device may perform the relevant calculations on the mathematical constructs. As used herein a NN may include deep neural networks (DNN), convolutional neural networks (CNN), probabilistic neural networks (PNN), time delay neural network (TDNN), deep stacking network (DSN), generative adversarial networks (GAN), recurrent neural network (RNN), long short-term memory (LSTM), etc.

The process of applying a large set of permutations upon the chosen hyperparameters is called hyperparameter tuning or hyperparameter optimization (HPO). During HPO, each permutation of hyperparameters requires executing at least one (and in most cases many more than one) full training process either upon the whole dataset, or upon portions of the dataset (data parallelism) or upon portions of the models (model parallelism), or combinations of the above, all performed to achieve a viable production-grade model that will satisfy the metrics desired for successful production-stage.

In many applications, a production-grade model may require maintenance, e.g., the model building and HPO may be repeated at time intervals after the model has been put to production if there is a data drift, e.g., a growing variance between the real-life data and the data used for training and/or if enhanced model types are introduced. As a result, the number of computations associated with building and maintaining an ML model is huge. An attempt to reduce the number of computations by reducing training, reducing HPO or reducing maintenance during production may inevitably result in a model's sub-optimal performance to start with, or its deterioration to ineffective usability over time.

Training of ML models, and their inference on live data during production, may be performed using on-premises computing power or using a cloud service. In both cases a complete runtime environment must be prepared for the training or inference to take place. For example, if the model being trained is a NN model, e.g., code or program written in the backend framework TensorFlow Keras, using open-source Python libraries such as NumPy, pandas and matplotlib, then a complete preparation must be performed on the computing device that will be running the training or inference processes, such that it has ready a “runtime environment” that will run the program and may include, inter-alia, an interface with hardware, e.g. compute unified device architecture (CUDA), the full stack of correct and updated software versions, libraries, etc. This preparation is mandatory to ensure successful code execution of the model training on that particular computing device.

For a training of a model to be executed by several computing devices, in a decentralized or distributed manner, this complex preparation task must be tailored for and installed on each variation of computing device. There is no one-fits-all runtime environment preparation script in existence, which would fit various computers, smartphones, tablets, car-infotainment systems (ICE) and the like. Each preparation process must thus be performed differently across the multitude of computing devices that are to be used in the execution of the distributed training task. For example, installation of Tensorflow on an Apple® laptop including an M1® chip and MacOS® operating system, is different than installation of Tensorflow on a Dell® laptop including an intel®-CPU, Nvidia® GPU and Windows® 10 operating system, and so on with each different computing device. Those skilled in the art will recognize that this constitutes an essentially insurmountable hurdle to actual implementation of large-scale decentralized or distributed computing resources utilization including training and inference of ML models across a multitude of computing devices.

Training of ML models may be performed using on-premises computing power, or a cloud computing service. Cloud computing services may provide large and scalable computing power. However, cloud computing requires lengthy and complex setup procedures, which vary from one cloud services provider to another, each designed to ensure a standard runtime environment for the computing devices owned and operated by the respective cloud services provider. In addition, cloud computing services are very expensive, due to their mandatory cost structure that may include buying computers, holding them on especially prepared real estate, maintaining them, cooling them, staffing them, etc. Thus, the financial costs of training and inference of ML models imposes additional, and in some cases prohibitive, difficulty for academics, students, researchers and commercially motivated scientific progress, to engage in deep learning research and technology innovation and progression.

On top of the direct costs, using a cloud service for training an ML model may involve opening an account, determining training setup parameters, such as the numbers, brand types and model types of CPUs, GPUs or TPUs to be used in training and HPO, and if training and HPO will be performed using these resources in parallel or consecutively. Those setup and preparation processes are usually site-specific, which makes the transition from one cloud service provider to another complex and expensive, (referred to as vendor lock-in) and require employees designated as “ML operations” or “MLOps”, to acquire unique expertise pertaining to a particular cloud service provider. However, despite those drawbacks, ML developers use cloud computing services for developing ML models due to a lack of any alternative to the vast computing power that only cloud computing services can provide.

Embodiments of the invention may include a system and method for providing decentralized computing resources to clients. According to embodiments of the invention, computing devices in homes, vehicles and enterprises may provide computing power for training ML models by such clients. According to embodiments of the invention, to operate as a trainer of an ML model, owners of those computing devices may only be required to have them connected to a network, e.g., the Internet and operate a readymade runtime environment (RRE). For example in personal computers, gaming consoles and mobile phones the RRE may be or may include a web browser, and in data center servers the RRE may be or may include a container (e.g., Docker or Podman). In an example RRE, the RRE may include all the necessary infrastructure to train or partially train an ML model as disclosed herein, and no other installations of software, agents, executables, runtime environments or libraries, adjustments and setups may be required, e.g., except for the installation of the RRE itself. Clients (e.g., computing devices or applications that train, optimize, run or maintain one or more ML models) and trainers (e.g., computing devices owned by persons or firms that may have available computing power for training or inferring ML models) may sign up to a service of ML training according to embodiments of the invention, without performing any specific installations, adjustments and setups as above.

According to embodiments of the invention, a service-level agreement (SLA) or service-level-objective (SLO) may be committed to by the service provider to the client for a task of training an ML model, which may be automatically assigned to be trained by any trainer that has available or free computing power (or available computing power that is above a threshold) and satisfies other considerations as sufficient for satisfying the SLA, e.g., by personal computers, servers, gaming consoles, rented virtual-machines, smart televisions, smart phones, media streaming devices, in-car infotainment systems and other processors distributed all over the world, that are connected to the internet and operate a web browser, a container or other suitable RRE, also referred to herein as a sandboxed environment. According to some embodiments of the invention, the utilization of such available computing power may be performed without tangible hinderance to the ongoing normal utilization of those computing devices. As used herein, free or available computing power may refer to computing power of a trainer that is currently not used by the trainer or that is assigned by the trainer for performing a portion of the task of training an ML model.

Furthermore, embodiments of the invention may improve ML development technology by providing a system and method for implementing the utilization of the decentralized computing resources automatically. According to embodiments of the invention, utilizing the decentralized computing resources automatically may include sending translated tasks to a plurality of trainers running computing devices of various types, without requiring any special adjustments on the side of the trainer, regardless of the specific type and architecture of the trainer. This stands in stark contradiction to prior art decentralized environments that are inherently not automatically implemented, e.g., require preparation on the side of the trainer which exceed the mere installation of a readymade runtime environment (such as a web browser, a container or a container engine, a Docker or Podman, etc.), and are not operable on a multitude of machines while being agnostic to each machine's special environment including hardware, operating system, drivers, etc.

Embodiments of the invention may include a system and method for providing decentralized computing resources. Embodiments of the method may include, using a main processor: translating a task (e.g., obtained or received from a client) of training or inference of a machine learning or neural network model, into a task gist, e.g., a code including the model structure, model weights, hyperparameters, other parameters associated with the model, and datasets, in a programming language and/or format that are executable by an RRE that enables interface or communication with a computer network such as the Internet, to generate a translated task; finding, among a plurality of computing devices (e.g., candidate trainers), at least one computing devices that has available computing power; transferring (e.g. via a network such as the Internet or another network) a portion of the translated task to each of the at least one computing devices; and obtaining results of execution of the portions of the translated task from the at least one computing devices, where the RRE may be configured to limit, prevent or block interaction between execution of the portions of the translated task and processes running on each of the at least one computing devices and between execution of the portions of the translated task and resources of each of the at least one remote computing devices. The main processor may convert the results of execution of the portions of the translated task to be readable in a programing language as requested by the client.

For clarity, extracting the task gist from a task obtained from the client in a first programing language, and optionally transforming the task gist to the programming language and/or format that are executable by an RRE, may be referred to herein as translating, and transforming the results of the execution, as obtained from the trainers back to be readable in the first programing language or another programing language and/or format that is required by the client may be referred to herein as converting. According to some embodiments, translating a task obtained from the client may include extracting from the task as obtained from the client, the model structure, model weights, hyperparameters, and datasets which together form the task gist. The task gist, e.g., the model structure, model weights, hyperparameters, and datasets may then be transformed into a format and/or programing language that is readable by a trainer.

Thus, embodiments of the invention may provide huge computing resources that are decentralized. Therefore, embodiments of the invention may improve the technology of training, optimizing, running and maintaining of ML models by providing computing resources to these ends. Benefits for the clients and ML developers may include accessible and less expensive computing power and simpler setup process, availability of very large computing power at short notice, automatic translation and distribution of training and inference assignments among the multitude of trainers. NN technology may be improved to more efficiently develop NNs. Benefits for trainers may include a new source of income paid for using their computing devices. Benefits for the environment may include an overall lower carbon footprint. Benefits to science and commerce may include lower barriers for the development, optimization, use and maintenance of useful ML models, for academics, students, researchers, and commercially motivated scientific innovation and progression, in both developed as well as emerging economies. Benefits for manufacturers of products containing computing devices or services providers utilizing such computing devices (e.g. personal computers manufacturers, gaming consoles manufacturers, car and electric car manufacturers, set top boxes services providers, mobile phone manufacturers, cellular networks services providers) may be in providing their goods or services at lower prices, thus splitting the value generated by these devices' joining in global decentralized computation, between themselves and/or their clients.

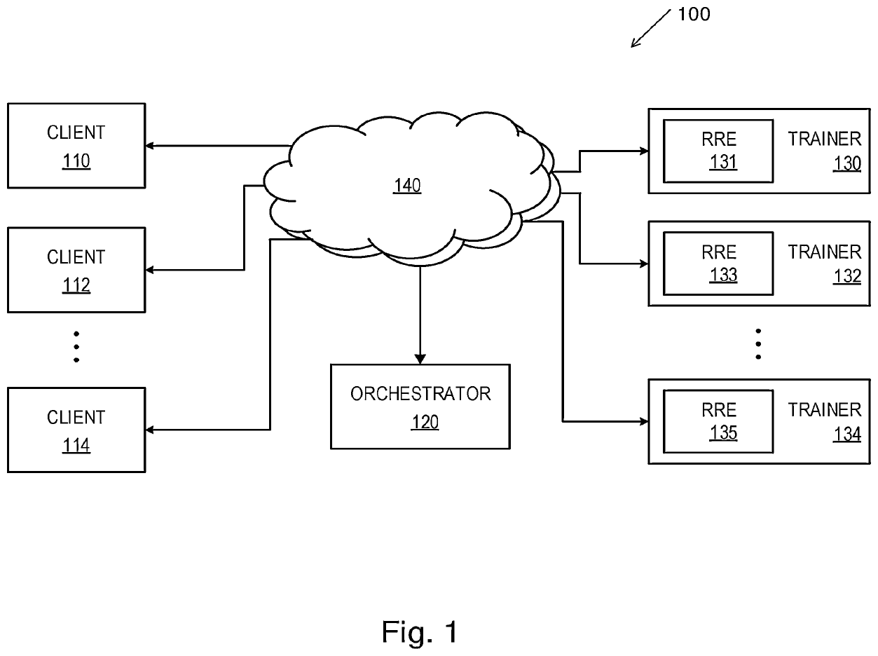

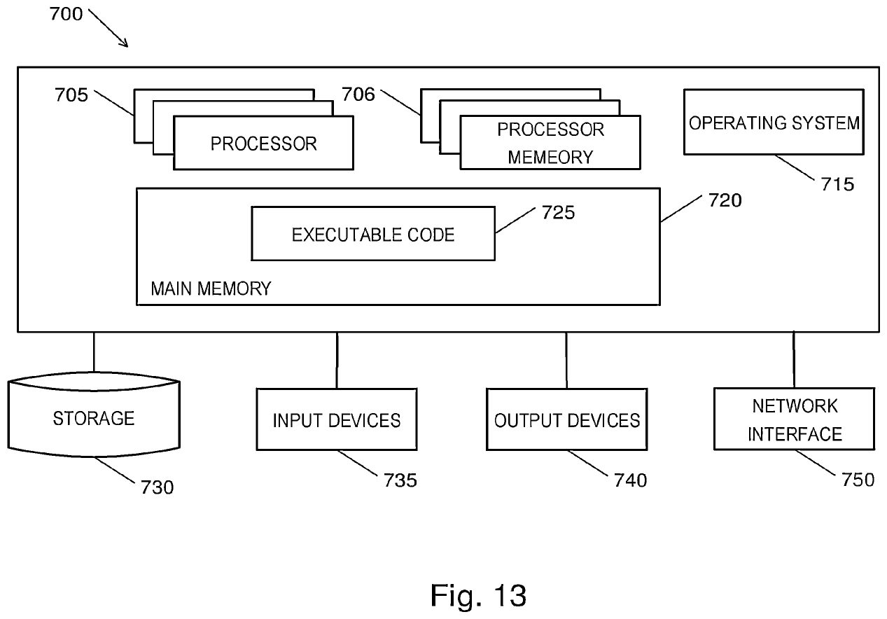

Reference is made to FIG. 1, which schematically illustrates a system 100, according to embodiments of the invention. System 100 may include one or more clients 110, 112 and 114 an orchestrator 120 and one or more trainers 130, 132 and 134. Each of clients 110, 112 and 114, orchestrator 120 and trainers 130, 132 and 134 may be or may include a computing device such as computing device 700 depicted in FIG. 13.

Networks 140 may include any type of network or combination of networks available for supporting communication between clients 110, 112 and 114, orchestrator 120 and trainers 130, 132 and 134. Networks 140 may be or may include for example, the Internet and intranet networks, a part of a private IP network, an integrated services digital network (ISDN), a set of frame relay connections, a public or private data network, a local area network (LAN), a wide area network (WAN), a wireline or wireless network, a cellular or satellite network, a local, regional, or global communication network, an enterprise intranet, a mesh network, and any combination of the preceding and/or any other suitable communication infrastructure. It will be recognized that embodiments of the invention are not limited by the nature, type or other aspects of network 140.

Any of client 110, 112 and 114 may initiate performing a computing task, referred to herein as a task or a job, e.g., training of an ML model or ML model inference. The ML model may include any type of learning model that requires training or inference such as, but not limited to, NN models, decision trees, gradient boosted trees, gradient boosting techniques, etc. For example, client 110 may provide a computer task, e.g., a training task, to orchestrator 120, as disclosed herein. The task may be provided through networks 140. The task may be provided as software code in any supported computer language or format, including, Python, C, C++, C#, ML specific languages or frameworks, etc. For example, a task for training an ML model (or model) may follow a call for training start (e.g., model.fit), and include model architecture or structure, model weights, training configuration and optimizer (e.g., in an H5 file), training or validation data (e.g., .npy files or .csv data frames), and separate training hyperparameters, including mini-batch size, epochs, loss function, accuracy metrics, optimizer, learning rate, callbacks, etc. As another example, the training hyperparameters may include n_estimators, tree_method, eta, max_depth, learning_rate, min_child_weight, subsample, colsample_bytree, reg_alpha, reg_lambda, early_stopping_rounds, etc. A task for a NN model inference (also referred to herein as inference) may include a call for inference to start (e.g. model.predict) model architecture and weights, and input data. A model.fit, or fit functions may refer to commands or functions included in any relevant ML software framework such as Tensorflow® Keras®, Scikit-Learn®, PyTorch®, or coding frameworks, that when executed perform training of an ML model or specifically a NN model.

Orchestrator 120 may obtain the task from client 110, automatically translate the task into a programing language, or programming languages in some embodiments, supported and executable by RREs 131, 133, and 135, thus generating a translated task. For example, orchestrator 120 may translate the task such that it is supported and executable in JavaScript by Internet browsers, or executable in Python or any other computer language supported by RREs 131, 133, and 135. In some embodiments, automatically translating the task may include extracting a task essence or gist from the task obtained from client 110. The task essence or gist may include the parameters and data required for training or inferring the model (depending on the type of the task). For example, in a task of training the machine learning model, the task essence or gist may include the model structure, the model weights, hyperparameters, and datasets. In a task of inferring using a trained ML model, the task essence or gist may include the model structure (e.g., the structure of the trained model), the model weights e.g., the weights of the trained model) and the input data. In some embodiments, automatically translating the task may further include adjusting or changing the format of the task essence or gist to be readable, executable or supported by RREs 131, 133, and 135.

[symbol] an ML software framework may include libraries. Those libraries may include files or modules that contain functions and data values for use by code executed by the ML software framework. Thus, executing a code for training an ML model or performing inference (e.g., executing the task) may require using at least part of the functions and data included in those libraries. Therefore, according to prior art, those libraries must be installed on the execution environment executing the task or a portion of the task of training an ML model. According to embodiments of the invention, installations of those libraries on trainers 130, 132 and 134 may be eliminated by generating the task essence or gist, since the task essence or gist may not require the functions and data included in those libraries.

In one example, the datasets of the original task may require preprocessing. For example, images (e.g., labeled images used for training the ML model) may require filtering, augmentations, size adjustments, etc., text may require transformations into feature vectors, audio data may require preprocessing, etc. In many applications, preprocessing of training datasets may include using functions provided in the libraries of the ML software framework. According to embodiments of the invention, as part of extracting the task gist, orchestrator 120 may perform the preprocessing, and include in the task gist datasets after preprocessing, that are ready to be provided to the ML model. In some applications, the ML model itself may require preprocessing. For example, an ML model may include embedding layers with readymade matrices that are included in the libraries of the ML software framework. According to embodiments of the invention, as part of extracting the task gist, orchestrator 120 may perform the preprocessing of the ML model, e.g., import the required matrices from the relevant libraries, include those matrices in the task gist and provide a complete ML model that does not require data from libraries of the ML software framework. Thus, RREs 131, 133 and 135 and trainers 130, 132 and 134 may not require preinstallation of libraries of the ML software framework in order to perform a portion of the task. Accordingly, an RRE 131, 133 and 135 including a standard Internet browser or a container may be used to perform a portion of the translated task without any specific adjustments.

Orchestrator 120 may distribute the translated task among one or more trainers 130, 132 and 134, each including an RRE 131, 133 and 135, respectively, e.g., Internet browsers and/or Dockers. Trainers 130, 132 and 134 may execute the portion of the translated task using RREs 131, 133 and 135. For example, orchestrator 120 may divide or partition the translated task into one or more portions, and send each portion to one of trainers 130, 132 and 134. According to some embodiments, orchestrator 120 may operate a website to implement embodiments of the invention. For example, orchestrator 120 may operate a website to communicate with RREs 131, 133, and 135 of trainers 130, 132 and 134, and with clients 110, 112, 114, to register clients 110, 112, 114 and trainers 130, 132 and 134, to obtain tasks from clients 110, 112, 114, to assign or send portions of the translated task to trainers 130, 132 and 134, in accordance with the programming code executable in each of RREs 131, 133, and 135, to obtain results from trainers 130, 132 and 134, to send results to clients 110, 112, 114, etc.

For a training task, the portions of the translated task sent to trainers 130, 132 and 134 may include translated versions of the model structure, model weights, training data, training hyperparameters (or parts of the model structure, model weights, training data, and training hyperparameters pertaining to the portion), as well as supplementary code that may be used for controlling the execution or performance of the portion of the task, e.g. engaging with orchestrator 120, reporting back to orchestrator 120, and/or control of the training process at the trainer level, e.g. the dynamic monitoring of free or available computing power at the trainer, and the dynamic utilization of the free or available computing power for purposes of training, etc. For an inference task, the portions of the translated task sent to trainers 130, 132 and 134 may include translated versions of the model structure, model weights, and input data, as well as supplementary code that may be used for controlling the performance of the portion of the task. While drawn as separated components, orchestrator 120 or parts thereof, may be implemented in client 110, e.g., as a software block or module. For example, is some embodiments, extraction of the task gist from the task may be performed implemented in client 110. In some embodiments, training of the ML model may continue until a criterion is satisfied, e.g., until metrics of performance, e.g., obtained from client 110, are achieved or until a number of epochs defined for example by client 110 is reached.

According to some embodiments, a portion of the translated task may include, a part, a portion, or a subset of the hyperparameters, the model structure or architecture, the model weights and the dataset; a part, a portion, or a subset of the hyperparameters, the model structure or architecture, the model weights and a portion of the dataset; a part, a portion, or a subset of the hyperparameters, a portion of the model architecture and weights and a portion of the dataset; or a portion of the hyperparameters, a portion of the model structure or architecture, and weights, and a portion of the dataset.

Trainers 130, 132 and 134 may include any type of computing device (such as computing device 700) that may provide computing power and resources for executing or performing at least a part or a portion of the translated task, e.g., at least a part or a portion of the model training or inference. Each of trainers 130, 132 and 134 may be a local computing device, e.g., connected to orchestrator 120 through a local network such as an Intranet, or a remote computing device, e.g., connected to orchestrator 120 through a wide network such as the Internet. The computing power may include processing power as well as available memory and other resources required for performing the translated task or portions thereof.

According to embodiments of the invention, each of trainers 130, 132 and 134 may include an RRE 131, 133, and 135, respectively, also referred to as sandbox, that may enable interfacing with network 140 and obtaining at least a part or a portion of the translated task. RREs 131, 133, and 135 may be or may include an environment for execution of code (e.g., software code), and may enable executing the obtained portion of the translated task. RREs 131, 133, and 135 may support execution of software code in at least one programing language, e.g., the programing language that can execute the translated task and supplementary code that may be used for controlling the execution or performance of the portion of the task. RREs 131, 133, and 135 may be configured to reduce, limit, prevent or block interaction between execution of the portions of the translated task and processes running on trainer 130, 132, 134 and between execution of the portions of the translated task and resources of trainer 130, 132, 134. According to some embodiments, RREs 131, 133, and 135 may be or may include an Internet browser, e.g., Google's Chrome®, Microsoft's Edge®, Apple's Safari®, etc., that is capable of executing JavaScript programming language, or a container e.g. Docker or Podman.

RREs 131, 133, and 135 may be or may include software applications that are configured to run or execute on varying computing devices (e.g., computers, video streaming devices, gaming consoles, smart phones, or dedicated hardware, such as computing device 700). RREs 131, 133, and 135 may be at least partially implemented by dedicated hardware. RREs 131, 133, and 135 may enable interface with the Internet, for purposes of receiving, transmitting, presenting and/or computing data from the Internet. RREs 131, 133, and 135 may be agnostic to the hardware and software environment in which they operate, e.g., the specific hardware and software environment of trainers 130, 132 and 134, in the sense that RREs 131, 133, and 135 may operate similarly, and provide users with similar services, across various hardware and software combinations. Specifically, RREs 131, 133, and 135 installed on computing devices (e.g., on trainers 130, 132 and 134) are agnostic to, and therefore compatible with hardware specifications of the computing devices, the operating systems (e.g., operating system 715 depicted in FIG. 13) of the computing devices, access schemes to the various hardware or software of the computing devices, and other services, processes, drivers, widgets, that may be executed by the computing device. RREs 131, 133, and 135 may all be able to natively execute at least one programming language. For example, all contemporary Internet browsers are such RREs and may be readily capable of executing HTML and JavaScript codes. Similarly, container engines may support programming languages such as Python and other programming languages as known in the art. RREs 131, 133, and 135 may be accompanied by a graphical user interface (GUI). While specific programming languages and environments are discussed, other languages and environments may be used.

According to embodiments of the invention, executing portions of the translated task on RREs 131, 133, and 135 may enable the portions of the translated task to be executed by trainers 130, 132 and 134 regardless of the specific hardware and software configuration of each trainer 130, 132 and 134, and without any preparation process required of users of these trainers 130, 132 and 134, while restricting possible interactions between that executed translated task and other processes running on trainers 130, 132 and 134 and other resources of trainers 130, 132 and 134. Thus, once each of RREs 131, 133, and 135 are installed and connected to the system (e.g., connected to a website of orchestrator 120) and operated by trainers 130, 132 and 134, respectively, no other preparations, installations, configurations and adjustments are required from trainers 130, 132 and 134 to execute a portion of the translated task and the supplementary code that may be used for executing the portion of the task, as disclosed herein.

According to embodiments of the invention, RREs 131, 133, and 135 may be a standard unit of software that include all of the necessary elements to execute software code or applications in any computing environment, e.g., on any of trainers 130, 132 and 134. For example, a container may include a package of an application software code together with dependencies such as libraries required to run the software code.

In some embodiments, RREs 131, 133, and 135 may be provided by the following components:
A plurality of preset processes, bundled with RREs 131, 133, and 135, where each of the preset processes may be associated with an aspect of functionality and user experience of RREs 131, 133, and 135. For example, the preset processes may include a process for playing video and audio, a process for reading files or writing files to the file system (e.g., main memory 720 and storage 730 depicted in FIG. 13), such as caching websites, storing cookies, saving images and the like, a process for communicating with a GPU, and many others. These preset processes are standardized and either come packaged with RREs 131, 133, and 135 or used by RREs 131, 133, and 135. Once RREs 131, 133, and 135 are respectively installed on trainers 130, 132 and 134, the respective users (e.g. owners or renters) of trainers 130, 132 and 134 are inherently limited to experiencing all processes run by RREs 131, 133, and 135 within the boundaries, e.g., constraints and limitations, that are preset within the processes bundled with RREs 131, 133, and 135. Any external code that requests privileges exceeding those that are available within the preset processes bundled with RREs 131, 133, and 135, will be denied those privileges.
Inter-Process-Communication (IPC)—a set of well-defined, sanitized messages that initiate the execution of the preset processes bundled with RREs 131, 133, and 135 or that RREs 131, 133, and 135 is configured to use. For example, video process may initiate pre-installed CODEC process using an IPC message.
A renderer process, which is in charge of executing external code, e.g., websites HTML & JavaScript.

The end-result of the structure of example RREs 131, 133, and 135 is that all functionality that is implemented by the processes bundled with RREs 131, 133, and 135 may successfully run on or be executed by any given trainer 130, 132 and 134, and vice versa, functionality that is not implemented by the processes bundled with RREs 131, 133, and 135 will not run on or be executed by trainers 130, 132 and 134.

Orchestrator 120 may divide the translated task into one or more portions, and send each portion to one of trainers 130, 132 and 134. For example, for a task or assignment of training a NN model, a portion of the translated task may include a structure of the NN model or a part of the NN model, weights and/or initial weights, and a particular combination of execution parameters and hyperparameters such as optimizer, loss function/s, metrics to be evaluated by the model during training, optimization, testing and inference, batch size (e.g., the number of samples in each mini-batch), steps per epoch (the number of batch iterations per epoch), number of epochs, types of callbacks to apply, augmentation parameters, and also a training and/or validation dataset or a portion thereof. The training dataset may be provided in chunks or mini-batches or any smaller segments, as disclosed herein.

One or more of trainers 130, 132 and 134 may execute the portion of the translated task assigned to them by orchestrator 120, within RREs 131, 133 and 135. Once completed, one or more of trainers 130, 132 and 134 may automatically send execution results to orchestrator 120. Orchestrator 120 may automatically aggregate, unify or integrate execution results from the different trainers 130, 132 and 134 to obtain the task results. Orchestrator 120 may convert the task results (e.g., the trained model weights or model predictions) to be readable in the original programming language of the task, and send the converted task results (e.g., the converted trained model or the converted model predictions) to client 110. For a training task, orchestrator 120 may obtain a trained model as associated with the portion of the translated task performed by each respective trainer 130, 132, 134, convert the trained model back to be readable in the original programming language in which the original task is provided by client 110, or in another programming language as required by client 110, and send the final results to client 110. For an inference task, orchestrator 120 may unify the results of obtain the model prediction.

According to some embodiments, orchestrator 120 may evaluate the task, and establish or estimate the amount of computing power that is required to execute the translated task within a predetermined time frame. Orchestrator 120 may determine a configuration for executing the translated task within the predetermined time frame or without any predetermined timeframe. For example, orchestrator 120 may evaluate or otherwise have knowledge of the amount of available computing power at trainers 130, 132 and 134, for example, orchestrator 120 may periodically or whenever needed, query trainers 130, 132 and 134 for their available computing power or obtain the available computing power from trainers 130, 132 and 134. Orchestrator 120 may evaluate the amount of computing power required to perform the translated task. Orchestrator 120 may divide the translated task into portions and allocate or assign the portions to one or more of trainers 130, 132 and 134 according to the amount of computing power that is required to execute the translated task within a predetermined time frame and the available computing power of trainers 130, 132 and 134. Orchestrator 120 may divide the translated task into portions requiring computing power that is equal to or below the available computing power of the assigned trainer 130, 132 or 134. In some embodiments, orchestrator 120 may divide the translated task into portions so that each portion may require the available computing power of one of trainers 130, 132 and 134 to be executed (or less). Thus, orchestrator 120 may assign a portion to a trainer 130, 132 or 134 that can be executed by the available computing power of that trainer 130, 132 or 134.

According to some embodiments, orchestrator 120 may negotiate with client 110 the terms and conditions of performing the task with client 110 to arrive at an agreed SLA. The SLA and/or SLO may define the level of service, e.g., time frame, and other parameters, expected by a client 110 from orchestrator 120 for completion of the task. Orchestrator 120 may also determine and provide a price for performing the task in the selected SLA to client 110. According to some embodiments, orchestrator 120 may negotiate the terms and conditions of performing the portions of the translated task with trainers 130, 132 and 134, including time frame, process, prices paid to trainers 130, 132 and 134, and other parameters.

According to some embodiments, orchestrator 120 may determine the SLA or the SLO for a task automatically based on considerations including but not limited to the number of trainers 130, 132 and 134 available, the free or available computing power of the available trainers 130, 132 and 134, the communications bandwidth (e.g., over networks 140) with trainers 130, 132 and 134, the price client 110 (e.g., the user) is willing to pay (the bid), the price that trainers 130, 132 and 134 require for using their computing power (the ask), etc. In some embodiments, orchestrator 120 may determine the SLA or SLO or price provided to client 110, and/or prices offered to trainers 130, 132 and 134 by an auction process between trainers 130, 132 and 134 competing for the right to execute the translated task or a portion thereof.

According to some embodiments, orchestrator 120 may automatically monitor the free or available computing power available and other performance indicators such as temperatures, available memory, available battery power, satisfaction of manufacturer usage limitations, at trainers 130, 132 and 134 while executing the portion of the translated task provided to them, e.g., the computing power of trainers 130, 132 and 134 that is not used for executing the respective portions of the translated tasks. In some embodiments, orchestrator 120 may automatically monitor the free or available computing power and satisfactory performance indicators as above, at trainers 130, 132 and 134, while not engaged in executing a portion of a translated task and may use this data to determine SLA or SLO. In some embodiments, orchestrator 120 may select trainers for executing a portion of a translated task, only from trainers 130, 132 and 134 with free or available computing power and satisfactory performance indicators as above, at any given present or past time frame, that is above respective thresholds. In some embodiments, orchestrator 120 may monitor the free or available computing power and satisfactory performance indicators as above, at trainers 130, 132 and 134, while each is engaged in executing a portion of a translated task and may use this information to automatically adjust the amount of computing power used by trainers 130, 132 and 134 to execute the portion of the translated task. For example, orchestrator 120 may dynamically adjust the portion of the translated task that is assigned to a trainer, and/or to adjust the amount of computing power consumed by trainer 130 for executing the portion of the translated task. For example, orchestrator 120 may increase the amount of computing power consumed by trainer 130 to execute the portion of the translated task if the free or available computing power of trainer 130 increases, and vice versa, decrease the amount of computing power used by trainer 130 to execute the portion of the translated task if the free or available computing of trainer power decreases. Orchestrator 120 may adjust the amount of computing power used by trainers 130, 132 and 134 to execute the portion of the translated task based on others performance indicators as well. For example, orchestrator 120 may increase the amount of computing power consumed by trainer 130 to execute the portion of the translated task if the performance indicators of trainer 130 increase or improve (e.g., temperature decreases), and vice versa, decrease the amount of computing power used by trainer 130 to execute the portion of the translated task if the performance indicators decrease or degrade (e.g., temperature increases).

In some embodiments, at least one of trainers 130, 132 and 134 may periodically, continually or continuously monitor the free or available computing power that the trainer is consuming, for executing the portion of a translated task assigned to that trainer by orchestrator 120, as well as the state of the performance indicators as above, and may use that information to automatically adjust the amount of computing power that the trainer is consuming to execute the portion of the translated task. For example, trainer 130 may increase the amount of computing power used by trainer 130 to execute the portion of the translated task if the free or available computing power of trainer 130 increases; and vice versa, decrease the amount of computing power consumed by trainer 130 to execute the portion of the translated task if the free or available computing power of trainer 130 decreases. Trainer 130 may adjust the amount of computing power used by trainers 130, 132 and 134 to execute the portion of the translated task based on others performance indicators as well. As another example trainer 130 may increase the amount of computing power consumed by trainer 130 to execute the portion of the translated task if the performance indicators of trainer 130 increase or improve (e.g. battery power or available memory increases), and vice versa, decrease the amount of computing power used by trainer 130 to execute the portion of the translated task if the performance indicators decrease or degrade (e.g. battery power or available memory decreases).

Training an ML model may require providing or feeding a training dataset into the ML model. A training dataset may include a plurality of samples. A sample may also be referred to as an instance, an observation, an input vector, a feature vector, a dataframe, and the like. A sample may include inputs that are fed into the ML model and an output that is compared to the prediction of the model to calculate an error, incorporated into a loss or cost function. In many applications the number of samples in a training dataset may be large, reaching even many millions of samples. Training an ML model is typically performed in epochs, where each epoch includes feeding the ML model with the entire training dataset (or a portion of the training dataset in the case of data parallelism training methods), and updating or adjusting the model weights and parameters thereupon. Training an ML model may include a plurality of epochs, where the same training dataset is used over and over again.

For example, some algorithms for training a NN model such as mini-batch gradient descent may enable training the NN model using mini-batches of data taken from the training dataset (or the training dataset portion in case of data parallelism training methods), instead of using the entire training dataset at once. When using mini-batch gradient descent to train a NN model, the training dataset may be divided into a plurality of mini-batches. Then, each sample in the mini-batch may be provided as input to the NN model and a prediction may be made. At the end of training session using the mini-batch, the resulting predictions are compared to the expected output variables and a mean error, objective function, loss or cost, and respective gradient is calculated. The mean error, loss or cost, and respective gradient is then used to train the NN model, e.g., to adjust the model weights, for example using backpropagation and/or other training methods. A mini-batch of data may include more than one sample and less than the whole dataset (or the portion of it as noted above). The size of the mini-batch may also be a hyperparameter that defines the number of samples to work through before updating the internal model weights.

According to some embodiments, orchestrator 120 may divide or partition the training data associated with or included in a portion of the translated task that is provided to a single trainer 130 into one or more mini-batches, where each mini-batch may include more than one sample and less than number of samples included in the training dataset associated with the translated task. In some embodiments, client 110 may divide the training dataset into one or more mini-batches. For example, the size or sizes of the mini-batches may be provided to orchestrator 120 as part of the training parameters. According to some embodiments, orchestrator 120 may start transmission of a portion of the translated task to trainer 130 by first transferring the model structure, weights, and training parameters. Next, orchestrator 120 may send, transfer, or transmit, either directly or in a mesh architecture, the training data to the trainer 130 in data shares, chunks or shards, where each data shard may include a single mini-batch, a plurality of mini-batches, or less than one mini-batch. A mini-batch may refer to a segment of the training data that may be sufficient for initiation of training.

Trainer 130 may begin training the NN model once the first mini-batch is obtained and may not have to wait for the transfer of the entire training dataset before starting to train the NN model. This may considerably reduce latencies in system 100, for example, the time taken from starting to transmit the translated task to trainer 130 to the time of starting to train the NN model by trainer 130 may be reduced. The overall time required for training the NN model may be decreased.

In some embodiments, a first shard of data may include a single mini-batch, while subsequent shards of data may include more than one mini-batches. In these embodiments, the size of the subsequent data shards, or the number of mini-batches included in each data shard sent to a trainer 130 may be determined or adjusted based on the speed of communication between orchestrator 120 and trainer 130 (e.g., the size or number or both may be adjusted or increase as the speed of communication increases and/or decrease as the speed of communication decreases). In some embodiments, the size of the subsequent data shards, or the number of mini-batches included in each data shard sent to a trainer 130 may be adjusted or determined based on the progress of the execution (e.g., percentage of tasks executed) of the portion of the translated task by that trainer 130 (e.g., the size or number or both may increase if the progress of the execution is above a threshold and decrease otherwise).

In some embodiments, client 110 may transfer or transmit the training dataset to orchestrator 120 in data shards, where each data shard includes a single mini-batch, a plurality of mini-batches, or less than one mini-batch, enabling orchestrator 120 to start transmission of mini-batches of data to trainer 130, before receiving the entire training dataset from client 110, which can reduce latencies in system 100. For example, the time from starting to transmit the task from client 110 to orchestrator 120 (or directly to trainer 130 in a mesh architecture), to the time of starting to transmit the translated task from orchestrator 120 to trainer 130 may be reduced, e.g., decreasing the overall time required for training the ML model. In some embodiments, a first shard of data may include a single mini-batch, while subsequent shards of data may be larger or include more than one mini-batches or both. In some embodiment, the size of the subsequent shards of data or number of mini-batches included in each data shard, or both, sent to orchestrator 120 from client 110 may be adjusted or determined based on the speed of communication between client 110 and orchestrator 120.

According to some embodiments, orchestrator 120 may send, transfer, or transmit the training dataset to the trainer 130 in data shards, where each shard includes less than a mini-batch. In this case, trainer 130 may automatically examine if a received chunk of training data includes a complete mini-batch. If yes, trainer 130 may automatically start training the NN model using the received mini-batch. If not, trainer 130 may automatically request another chunk from orchestrator 120, or simply wait until another chunk is obtained from orchestrator 120 and start training the NN model once a full mini-batch is obtained. Obtaining data shards of training data may continue until the entire training dataset required for completing the portion of the translated task is transmitted to trainer 130.

For example, in a complete training dataset that includes 2,000,000 samples, a mini-batch may include 10 samples, Orchestrator 120 may start transmission of data shards that may include mini-batches of samples to trainer 130, after receiving only 10 samples, and before receiving the entire 2,000,000 samples. Continuing with this example, trainer 130 may automatically start to train the NN model after receiving the first 10 samples only (e.g., a single mini-batch), and before receiving the entire 2,000,000 samples included in the training dataset. The mini-batches may be stored by trainer 130 for the next epochs as described below.

According to some embodiments, trainer 130, after having received the full dataset (or portion thereof) assigned to trainer 130, may automatically save the received dataset to a local storage of trainer 130. Saving the received dataset to a local storage may eliminate the need to transfer the dataset again as the translated task is being executed thereby.

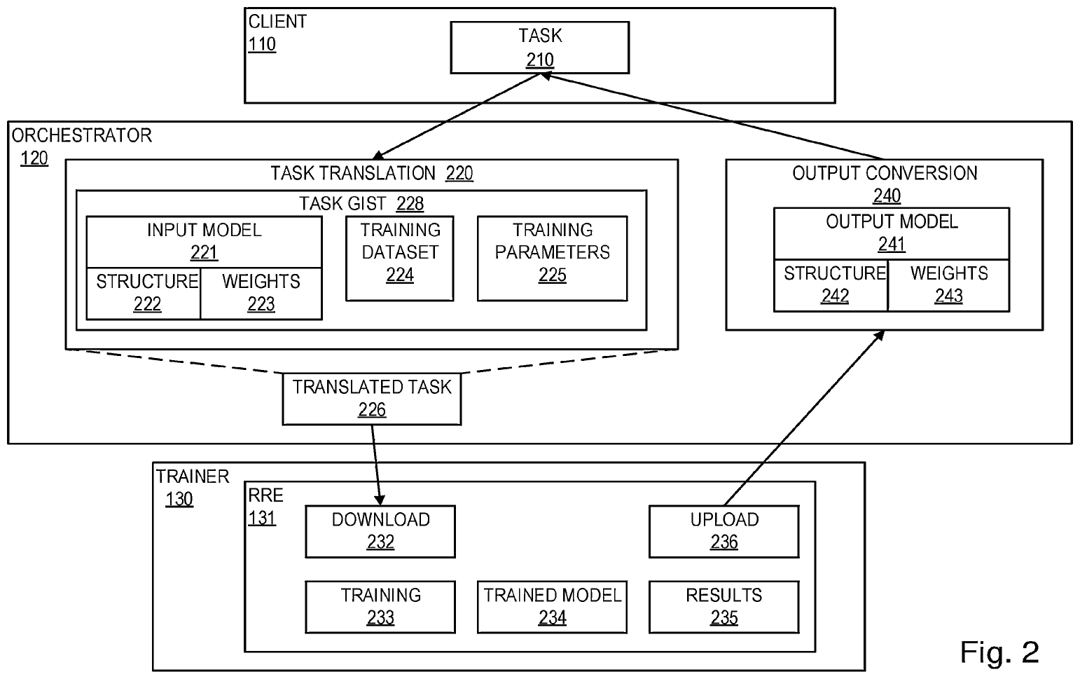

Reference is now made to FIG. 2 which schematically illustrates the dataflow between client 110, orchestrator 120 and trainer 130, according to embodiments of the invention. As can be seen in FIG. 2, client 110 may generate or initiate a task 210. For example, task 210 may include training an ML model and thus may include input model 221, including a structure 222 of the model and weights of the model 223 (e.g., initial and/or other intermediate weights), training dataset 224, and training parameters (also referred to herein as hyperparameters) 225. and may be provided in any programing language that is supported by orchestrator 120, e.g., Python or JavaScript. Orchestrator 120 may obtain the task 210 and automatically, by translation module 220, extract the task gist 228 including structure 222, weights of the model 223 training dataset 224, and hyperparameters 225 to generate a translated task 226. The translated task 226 may be generated by translating task 210 or task gist 228 into a code that is supported by and executable by RRE 131, e.g., Python or JavaScript. According to some embodiments, translating a task by translation module 220 may include extracting from the task as obtained from client 110, the task gist or essence 228 including the model structure 222, model weights 223, hyperparameters 225, and datasets 224. In some embodiments translation module 220 may be implemented in or executed by client 110. The task gist 228 may then be transformed into a format and/or programing language that is readable by a trainer 130. Translated task 226 or task gist 228 may be divided by orchestrator 120 into portions. Each portion may be provided by orchestrator 120 to each of RREs 131 of a trainer 130, RRE 133 of trainer 132, RRE 135 of trainer 134, each in code that is executable by the respective RRE 131, 133 and 135, etc. RRE 131 of trainer 130 may automatically download 232 the portion of the task as disclosed herein, train 233 the ML model using the model structure, model weights, training dataset and training parameters included in the respective portion of translated task 226 or task gist 228, and generate a trained model or a partially trained models 234, e.g., provide a structure 242 and weights 243 of the trained model or the partially trained models, and other relevant data such as training assignment information artifacts such as total epoch time, loss values at each specific epoch or step, etc., if applicable, together forming the translated task results 235). According to embodiments of the invention, downloading 232 training 233 and uploading 236 may be implemented within RRE 131. For example, trainer 130 may access the website operated by orchestrator 120 by feeding a link to RRE 131, e.g., a browser, and the interaction may be similar to the interaction with a regular website.

RRE 131 of trainer 130 may automatically return (e.g., via network or Internet 140) translated task results 235 to orchestrator 120. Output conversion module 240 of orchestrator 120 may automatically convert the translated task results, obtained from the trainers 130, 132, 134, into any programming language or format as required by client 110 and supported by orchestrator 120, to obtain converted trained model 241. Orchestrator 120 may automatically provide or transmit the converted trained model 241 to client 110.

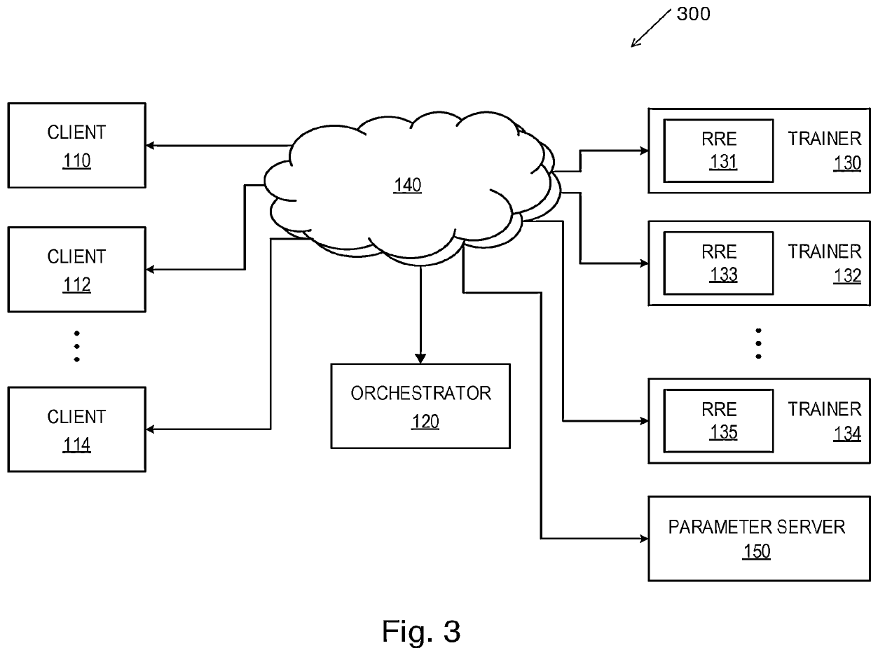

Reference is made to FIG. 3, which schematically illustrates a system 300, according to embodiments of the invention. Components in system 300 are similar to those of system 100 depicted in FIG. 1, with the addition of a parameter server 150. Parameter server 150 may be implemented in a separate server, as a block in orchestrator 120 or by a trainer, e.g., one of trainers 130, 132 and 134 may operate as parameter server 150. Parameter server 150 may help system 300 to support data parallelism, or model parallelism combined with data parallelism.

According to some embodiments, the translated task may be executed by system 300 using data parallelism method. For implementing data parallelism, results of portions of the translated task may be sent by each of trainers 130, 131, 132 to parameter server 150. For example, results of the portions of the translated task may be sent by each of trainers 130, 131, 132 to parameter server 150 after each epoch. Parameter server 150 may unify, aggregate, integrate, or combine the results of the portions of the translated task and send updated versions of the portions of the translated task to trainers 130, 131, 132. For example, parameter server 150 may combine results from a plurality of trainers 130, 131, 132 to update weights of a NN model and provide the updated model weights to trainers 130, 131, 132, for performing the next epoch with the updated model. After completing all epochs, e.g., when a criterion is satisfied, parameter server 150 may unify, aggregate, integrate, or combine the results from trainers 130, 131, 132, to arrive at the final trained model (e.g., the final model structure and weights), and may provide the trained model back to orchestrator 120. The criterion may include one or more predefined metrics of performance or a number of epochs, and may be defined by client 110.

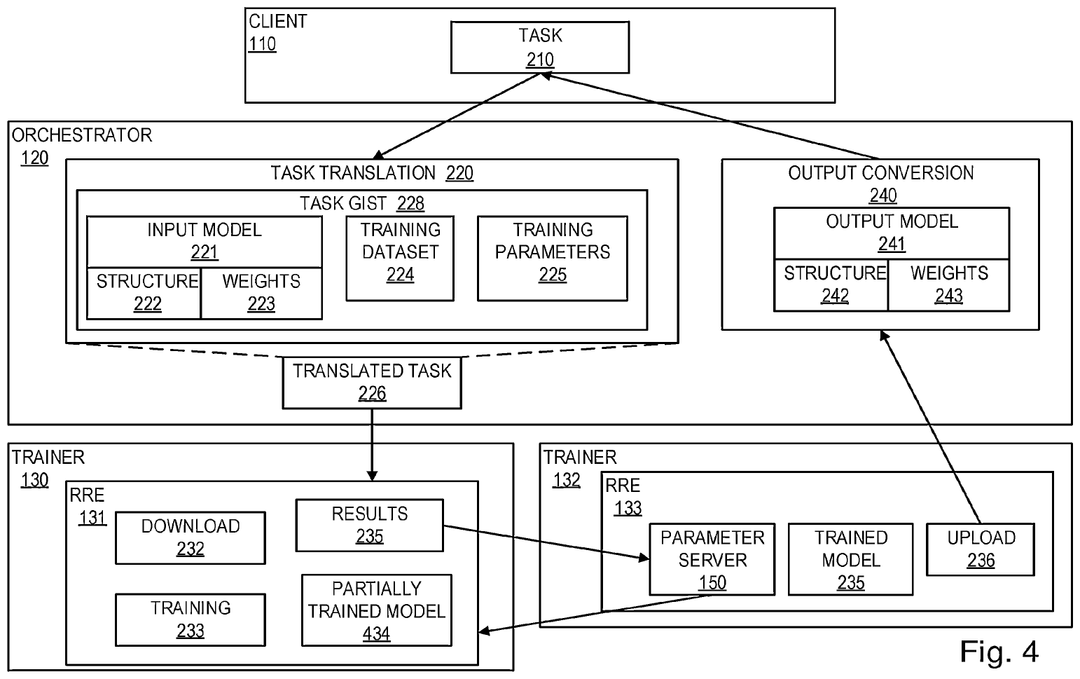

Reference is now made to FIG. 4 which schematically illustrates an example dataflow between client 110, orchestrator 120 trainer 130 and parameter server 150, according to embodiments of the invention. Parts of the dataflow presented in FIG. 4 are similar to those presented in Fig. S2. In FIG. 4, however, trainer 132 implements parameter server 150 within its RRE 133. Thus, trainer 130 (and other trainers that are taking part in training the same ML or NN model to which belongs the portion of the translated task sent to them) may send training results 235, for example, including a partially trained model 434 and other relevant data, after completing each epoch, to parameter server 150. Parameter server 150 may unify the results obtained from the plurality of trainers (e.g., trainer 130 and others). For example, parameter server 150 may update the weights of an entire NN model, and may return the updated parameters (or parts therefrom, as required) to trainer 130 (and other trainers that are taking part in training the same ML or NN model). After training is completed, parameter server 150 may unify, aggregate, integrate, or combine the results from trainers 130, 131, 132, to arrive at the final trained model 235 (e.g., the final model structure and weights), and may provide or upload 236 the trained model back to orchestrator 120.

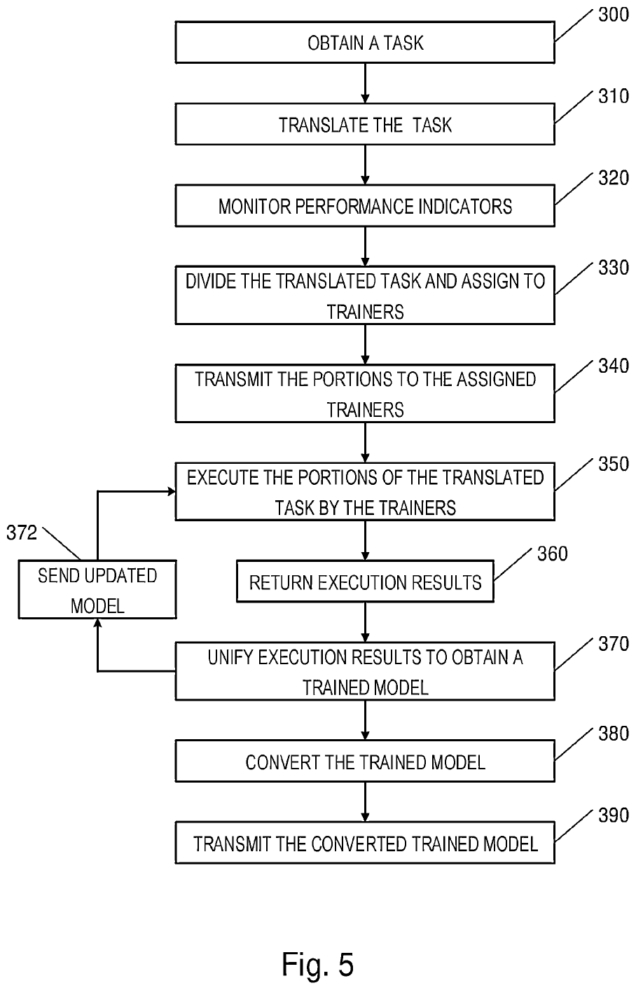

FIG. 5 is a flowchart of a method for providing decentralized computing resources for training an ML model, according to some embodiments of the present invention. While in some embodiments the operations of FIG. 5 are carried out using systems as shown in FIGS. 1, 2 and 13, in other embodiments other systems and equipment can be used. In operation 300, a processor (e.g., processor 705 depicted in FIG. 13) may obtain a task, e.g., from a client such as client 110. The task may include training an ML or NN model and may be provided in any supported programming language or format. The task may include the input model 221, including a structure 222 of the model, and weights of the model 223 (e.g., initial or other intermediate weights), training dataset 224, and training hyperparameters 225, etc. The processor may agree or automatically commit to an SLA and/or SLO with the client. In operation 310, the processor may automatically translate the task such that it is supported and executable by the RREs of a plurality of trainers, e.g., executing Python or Javascript, to generate a translated task. According to some embodiments, translating a task may include extracting, from the task as obtained from the client, the task gist or essence including the model structure, model weights, hyperparameters, and datasets. The structure, model weights, hyperparameters, and datasets may then be transformed into a format and/or programing language that is readable by a trainer.

In operation 320 the processor may automatically monitor, estimate or obtain (e.g., from the trainers) the free or available computing power and/or other performance indicators available at the plurality of trainers. In some embodiments, the processor may automatically determine the SLA based on the free or available computing power and/or other performance indicators available at the plurality of trainers. In operation 330, the processor may automatically divide the translated task into portions and assign each portion to one of the plurality of trainers. For example, division, and then assignment of portions to trainers may be performed based on the available computing power and/or other performance indicators at the trainers, the SLA, the SLO, trainer's hardware, the communication speed and bandwidth available to each of the trainers, and other parameters. In operation 340, the processor may automatically transmit or provide each portion to the selected trainer. The portion may be provided or transmitted in whole or in chunks (data-shards). For example, the processor may transmit or provide the model structure, weights and hyperparameters first, and only then chunks of training data, organized in data-shards that may include training mini-batches. In operation 350, the selected trainers may automatically execute the portion of the translated task assigned to them, in an RRE. In operation 360, the trainers may transmit the execution results back to the processor. In optional operation 370, the processor (e.g., a parameter server) may unify, combine or aggregate the execution results obtained from the plurality of trainers, for example to support data parallelism or model parallelism or gradient accumulation or all three. In some embodiments, operation 370 may be repeated after each epoch, each mini-batch, and the updated model, e.g., the updated model parameters, may be sent back to the trainers for further training, as indicated in operation 372, until arriving at the final trained ML model. In operation 380, the processor may automatically convert the trained model, including weights, model architecture, hyperparameters and/or any training task information artifacts (referred to as the converted trained model) such that it is readable in a programming language or format agreed upon with the client that has provided the task in operation 300. In operation 390, the processor may provide or automatically transmit the converted trained model to the client from which the task was obtained in operation 300. In some embodiments, operations 350, 360 and 370 and 372 (if applicable), may be repeated until a criterion (e.g., one or more predefined metrics of performance or a number of epochs) is satisfied.

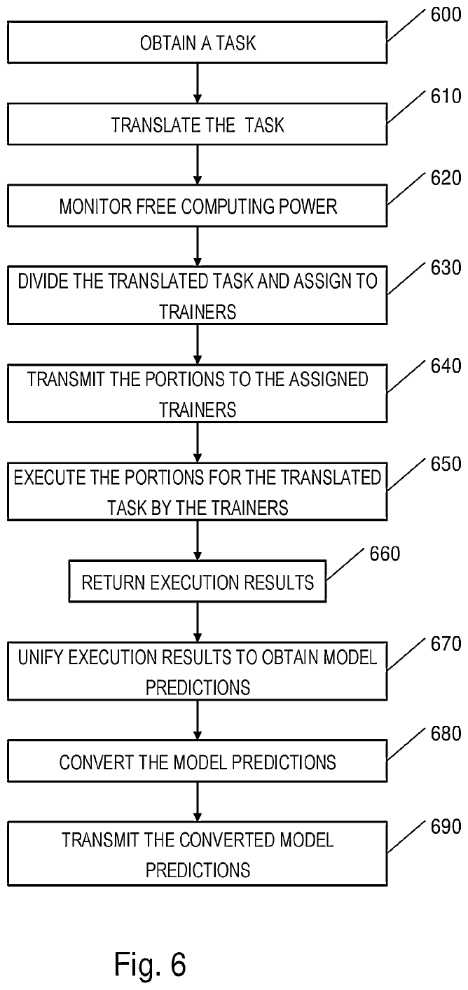

FIG. 6 is a flowchart of a method for providing decentralized computing resources for an ML model inference, according to some embodiments of the present invention. While in some embodiments the operations of FIG. 6 are carried out using systems as shown in FIGS. 1, 2 and 13 in other embodiments other systems and equipment can be used. In operation 600, a processor (e.g., of processor 705 presented in FIG. 13) may obtain a task, e.g., from a client such as client 110. The task may include an ML or NN model inference and may be provided in any supported programming language or format. The task may include the input model 221, including a structure 222 of the model, and weights of the model 223, input data, etc. The processor may agree or automatically commit to an SLA and SLO with the client. In operation 610, the processor may automatically translate the task such that it is supported and executable in a programing language that is supported by an RRE of a plurality of trainers, e.g., in Javascript or Python, to generate a translated task. According to some embodiments, translating a task by translation module 220 may include extracting from the task as obtained from client 110, the task gist or essence including the model structure, model weights, and input data. The structure, model weights and input data may then be transformed into a format and/or programing language that is readable by RRE 131 executed by trainer 130.

In operation 620 the processor may automatically monitor or obtain (e.g., from the trainers) the free or available computing power and/or other performance indicators available at the plurality of trainers. In some embodiments, the processor may automatically determine the SLA or SLO based on the free or available computing power and/or other performance indicators available at the plurality of trainers. In operation 630, the processor may automatically divide the translated task into portions and assign each portion to one of the plurality of trainers. For example, assignment of portions to trainers may be performed based on the available computing power and/or other performance indicators at the trainers, the SLA, the SLO, trainer's hardware, the communication speed and bandwidth available to each of the trainers, and other parameters. For example, portions may be assigned to trainers such that each portion is executable by the code execution environment or RRE of the assigned trainer (e.g., the assigned computing device) using the available computing power of the assigned trainer. In operation 640, the processor may automatically transmit each portion to the selected trainer. In operation 650, the selected trainers may automatically execute the portion of the translated task assigned to them, in an RRE. In operation 660, the trainers may transmit the execution results (e.g., model predictions) back to the processor. In optional operation 670, the processor may unify, combine or aggregate the execution results obtained from the plurality of trainers. In operation 380, the processor may automatically convert the model predictions to a code or format readable in a programming language agreed upon with the client that has provided the task in operation 600. In operation 690, the processor may provide or automatically transmit the converted model predictions to the client from which the task was obtained in operation 600.

In some embodiments, the method involves gradient accumulation. Gradient accumulation may involve inserting an interim step between training each sample and the training of a mini-batch. The interim step may include splitting each mini-batch into micro-batches, which are then trained in sequence: each micro-batch may undergo forward propagation, and then the gradients of that micro-batch may be calculated and multiplied by their proportional part in the mini-batch (e.g., by the number of samples in the micro-batch divided by the number of samples in the respective mini-batch) to generate partial gradients. The partial gradients may be accumulated for each micro-batch. This process may repeat itself, micro-batch after micro-batch, until the partial gradients of the final micro-batch that makes a mini-batch are added. At that point the model's weights may be updated with respect to the accumulated gradients in a back propagation process, before proceeding to train the next mini-batch. Each mini-batch may be split into micro-batches, then trained as above, until all mini-batches are trained, e.g., until a training of a full epoch is accomplished. The application of gradient accumulation may be mathematically identical (or substantially mathematically identical) to processing of the whole mini-batch using forward and backward propagation. Hence, the application of the gradient accumulation as disclosed herein, at a system for providing decentralized computing resources for training an ML model, e.g., at orchestrator 120 and/or at trainers 130, 132 and 134 of system 100 (depicted in FIG. 1) may not affect or hinder the results obtained by clients 110, 112 and 114.

According to embodiments of the invention, dividing (e.g., logically dividing) of a mini-batch to a plurality of smaller micro-batches and using gradient accumulation may be beneficial for embodiments of the system for training an ML model using decentralized computing resources, e.g., system 100 or 200. First, this may enable using trainers 130, 132, and 134, that have lower performances, e.g., lower available memory space (e.g., the memory space available for the one or more processors of the trainer) that may not be big enough to train a complete mini-batch but may still be sufficient for training a micro-batch. This may allow using more trainers 130, 132, and 134 in system 100, e.g., trainers that would have otherwise not participated in the training, and by this improving the overall performance of system 100. In many applications, the size of a mini-batch may be dictated by the client as part of the hyperparameters of the task. Thus, if the size of a mini-batch as provided by the client is large, it may be difficult and in some cases even impossible for orchestrator 120 to find suitable trainers among trainers 130, 132, and 134, since orchestrator 120 may have limited flexibility in determining a size of a portion (e.g., the computing power that is required to execute a portion may not be larger than the computing power that is required to calculate gradients of a single mini-batch). A size of a micro-batch may be determined independently by orchestrator 120 or by each of trainers 130, 132, and 134 for itself, in accordance with the capabilities of trainers 130, 132, and 134, e.g., in accordance with the available memory size of each of trainers 130, 132, and 134 and other performance parameters. The performance parameters such as the available computing power and the available memory size, of each of trainers 130, 132, and 134 may change over time, even during execution of a single training task. According to embodiments of the invention, the division of a mini-batch to a plurality of smaller micro-batches may change over time as well. Orchestrator 120 and trainers 130, 132, and 134 may have the ability to dynamically adjust the size of the micro-batch in accordance to the size of the currently available memory space of each of the processors (e.g. GPU's) in each of the trainers 130, 132 and 134, the total memory space of the processors in each of the trainers 130, 132 and 134, and the computing power of each of the processors and of all processors combined, of each of trainers 130, 132, and 134.

Embodiments of the invention may improve the technology of decentralized ML model training by enabling more trainers to participate in the training process. As disclosed herein trainers or processors that may not be able to execute a complete mini-task, may be assigned with a mini-task portion that requires less processing power and memory than a mini-task. This may enable the system to execute training tasks that would otherwise be impossible to train due to insufficient processing power in trainers in the system, and may expedite processing time by dividing a mini-task among a plurality of trainers that may operate in parallel to each other.

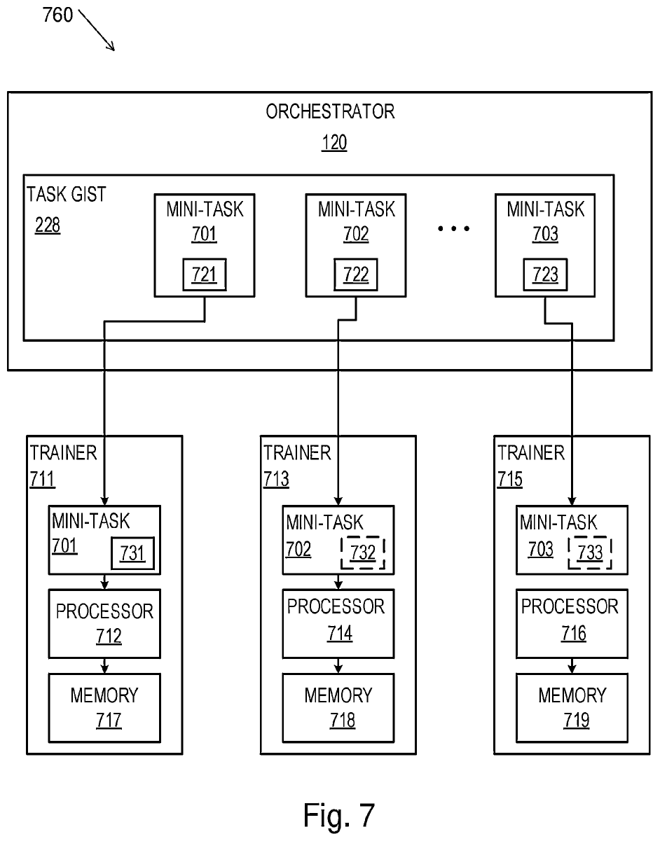

Reference is now made to FIG. 7 which is a schematic illustration of a system 760 for providing decentralized computing resources, according to embodiments of the invention. Embodiments of system 760 may be similar to embodiments presented in FIGS. 1-4, with added functionally as disclosed hereinbelow. Similar components may have the same reference numerals and may not be explained again. System 760 may include orchestrator 120, and trainers 711, 713 and 715. Each of orchestrator 120 and trainers 711, 713 and 715 may be or may include a computing device such as computing device 700 depicted in FIG. 13, which includes at least one processor 705 and processor memory 706, e.g., each of processors 712, 714 and 716 may be or may include one or more processor 705, and each of memory modules 717, 718 and 719 may be or may include processor memory 706. Trainers 711, 713 and 715 may be similar to trainers 130, 132 and 134 and may or may not include an RRE (not shown).

According to embodiments of the invention, orchestrator 120 may obtain a task 210, e.g., from a client such as client 110 or from other source, extract a task gist 228, and generate a translated task 226 as disclosed herein. Orchestrator 120 may further divide or partition the task gist 228, the task 210 and/or the translated task 226 into portions or mini-tasks 701, 702 and 703. While task gist 228, task 210 and translated task 226 may each include a model structure, model weights, datasets, and hyperparameters, each of mini-tasks 701, 702 and 703 may include the model structure, the model weights, the datasets, and a subset of the hyperparameters that includes at least one mini-batch size. For example, mini-task 701 may include mini-batch size 721, mini-task 702 may include mini-batch size 722 and mini-task 703 may include mini-batch size 723. While each of mini-tasks 701, 702 and 703 may include more than one mini-batch sizes, the explanation below is given for a single mini-batch size per mini-task for clarity. It is noted that if a mini-task 701, 702 and 703 includes more than one mini-batch sizes, the process below is similar or identical for each mini-batch size.

In many applications, the mini-batch size 721, 722 and 723, as well as the model structure, the model weights, the datasets, the other hyperparameters may be defined by a user (e.g., defined by a data scientist, included in task 210 and provided by client 110, or from another source) as part of the task of training an ML model. Thus, orchestrator 120 may obtain the at least one mini-batch size 721, 722 and 723 as a given, and may not be allowed (e.g., by a user or by client 110) to make any changes in the at least one mini-batch size 721, 722 and 723.

As disclosed herein orchestrator 120 may attempt to designate or assign one or more mini-tasks 701, 702 and 703 to one or more of trainers 711, 713 and 715, according to the free or available computing power, memory space and/or other performance indicators of trainers 711, 713 and 715. The performance indicators may be related to a trainer 711, 713 and 715 or to each processor 712, 714 and 716, within the trainer. For example, the performance indicators of a trainer 711 may include the memory space in memory 717 of each of the processors 712 of trainer, the total memory space of the processors in trainers 711, frequency of past dynamic adjustments of the size of the micro-batch assigned to trainer 711, specifications of each processor 712 of the trainer 711, sample processing rate of each processor 712 in trainer 711, etc.

However, in some scenarios, some or all of trainers 711, 713 and 715 may not have sufficient free or available computing power, memory space and/or other performance indicators to execute mini-tasks 701, 702 and 703 with the provided mini-batch size 721, 722 and 723, respectively. For example, the available processors' (e.g., GPUs') memory space of one or more of trainers 711, 713 and 715 may not be sufficient for executing a portion having a mini-batch size 721 as defined in the hyperparameters of the portion.

According to embodiments of the invention, system 760 may apply gradient accumulation in one or more of trainers 711, 713 and 715, and define a micro-batch size 731, 732 and 733 that is smaller than the mini-batch size 721, 722 and 723 for one or more of mini-tasks 701, 702 and 703, respectively. For example, orchestrator 120 may determine or calculate a micro-batch size 731 that is smaller than mini-batch size 721 and small enough to enable a trainer 711 that was otherwise incapable of performing or executing a mini-task 701 to be able to perform or execute the mini-task 701.

According to embodiments of the invention, orchestrator 120 may obtain, e.g., from each of trainers 711, 713 and 715 an estimation of at least one performance indicator of that trainer. The performance indicator may include available memory space of each processor in the trainer, computing power of each processor in the trainer, total memory space of the processors in the trainer, frequency of past dynamic adjustments of the size of the micro-batch assigned to the trainer, specifications of each processor of the trainer and sample processing rate of each processor in the trainer, and other relevant performance indicators. Orchestrator 120 may determine or calculate a maximal micro-batch size for each of the processors (e.g. GPUs) in trainer 711, 713 and 715 based on the performance indicator of the respective trainer, and parameters of the mini-task, such that this maximal micro-batch size is small enough to enable at least one of processors in trainer 711, 713 and 715 to perform or execute the mini-task 701.

In some embodiments, the performance indicator of a trainer 711, 713 and 715 may include the available memory space of each or all of the processors (e.g., GPUs) in trainer 711, 713 and 715, and the parameters of the mini-task may include memory space required for storing the ML model (MEM_ML) and memory space required for storing a sample (MEM_SAMPLE) of the plurality of samples included in the mini-task 701, 702 and 703. Thus, orchestrator 120 may determine or calculate a maximal micro-batch size (max_MBS) that may fit the available memory space in at least one processor 712, 714 and 716 (e.g. GPU) in trainer 711, 713 and 715 by, for example (other equations may be used):

$$( Equation 1 )$$

$$max\_MBS = \frac{\begin{matrix}AVAIL\_MEM - \\ ( n * TRAIN\_PARAM + NONTRAIN\_PARAM )\end{matrix}}{MEM\_SAMPLE + m * MEM\_ACT}$$

Where AVAIL_MEM is the available memory space of a processor (e.g., GPU) in a trainer, TRAIN_PARAM is the memory space required to store the model parameters that are being trained during training, NONTRAIN_PARAM is the memory space required to store the model parameters that are not being trained during training, MEM_SAMPLE is the memory space required to store a single sample of the training data, MEM_ACT is the memory space required to store the intermediate computation results generated during the forward and backward passes of the training, n and m are positive parameters used to generate safety margins for the calculated maximal micro-batch size. It is noted that in the theoretical case n=3 and m=2, for the following reasons: m=2 since MEM_ACT is required in both the forward and backward propagation of training; and n=3 since TRAIN_PARAM comprises 3 components: weights, gradients and optimizer variables. However, the actual memory usage during training may be different than the theoretical calculation due to various factors such as the processor (e.g., GPU) fragmentation, memory allocation overhead, etc. Therefore, safety margins may be added to the calculated memory usage to avoid running out of memory during training. Exemplary values for n and m, may include, n=3 and m=2 n=5 and m=3, n=3 and m=5, etc. Other safety margins may be used. In some applications, the units in Equation 1 may be defined by the data type used for training, e.g., 16-bit floating point, 32-bit floating point, etc.

Alternative or additional performance indicators may be used, for example, the performance indicator of a trainer 711, 713 and 715 may include the available memory space, a frequency of past dynamic adjustments of the size of the micro-batch designated or assigned to the trainer 711, 713 and 715, the free or available computing power, the specifications of the processor or processors of trainer 711, 713 and 715, and performance statistics of trainer 711, 713 and 715 such as a sample processing rate, e.g., the time it took the trainer to process a single sample during training, etc. The past dynamic adjustments of the size of the micro-batch may refer to the frequency and time of changes made to the size of the maximal micro-batch of a trainer during execution of a training task, which may divert from the maximal micro-batch that are assigned before beginning of training. Orchestrator 120 may further adjust the maximal micro-batch size for at least one of the processors (e.g., GPUs) in trainers 711, 713 and 715 based on its other parameters. For example, maximal micro batch size may be reduced if the micro batch size change rate increases, e.g., the maximal micro-batch size may be inversely related to the micro batch size change rate that was recorded for a processor, as described below. The maximal micro batch size of the at least one processor of a trainer with a high micro batch size change rate may be reduced since a high micro batch size change rate may be a sign of a problem with that processor, e.g., a weak fan or hot environment, leading to low performance and a lower actual micro batch size during training.

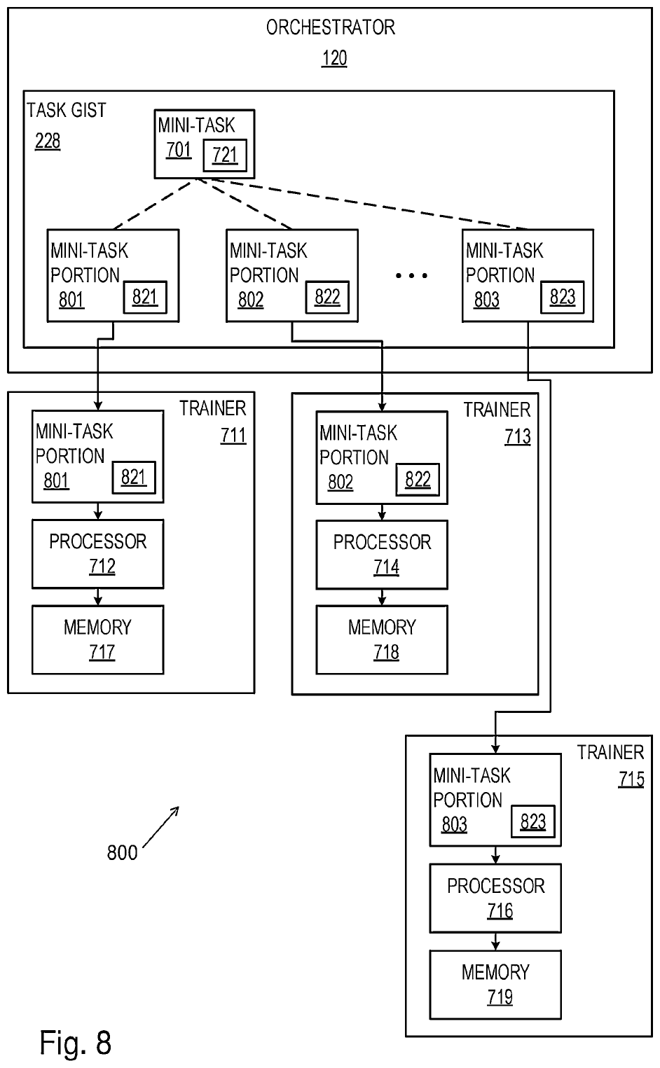

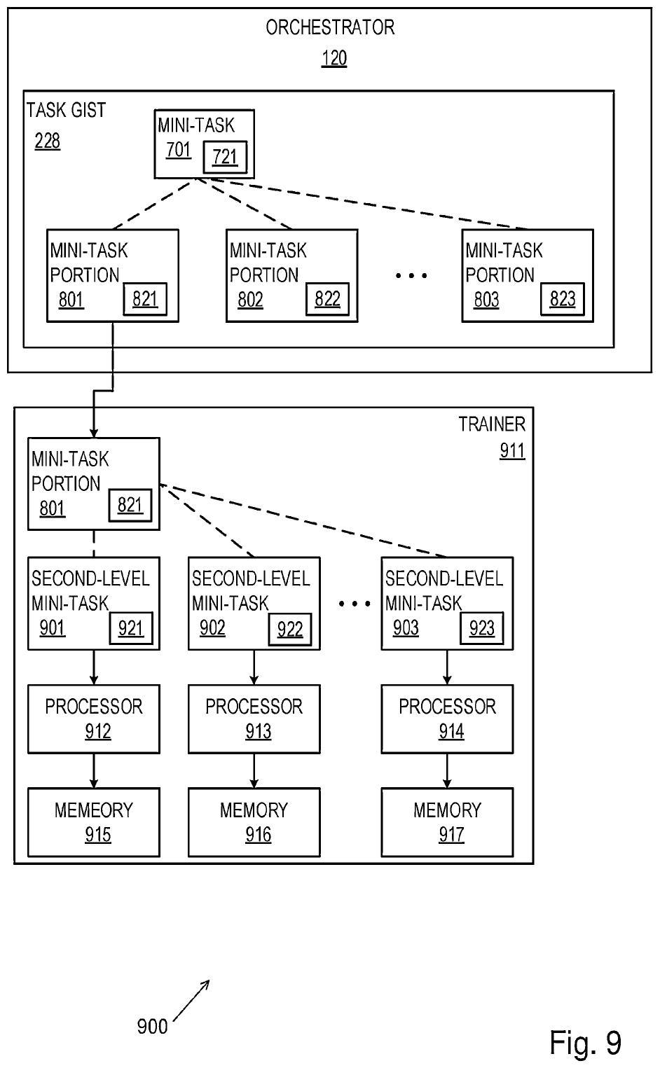

According to embodiments of the invention, in a trainer with multiple processors, e.g., trainer 911 presented in FIG. 9, that includes processors 912, 913 and 914, each of processors 912, 913 and 914 may be allocated with different size of memory 915, 916 and 917, respectively, and may have a different estimated or calculated maximal micro-batch size (e.g., calculated according to Equation 1). In a system with a plurality of trainers, e.g., system 800 presented in FIG. 8, that includes trainers 711, 713 and 715, each allocated with processor memory 717, 718 and 719, respectively, if two of those trainers, e.g., trainers 711 and 713 have identical specifications except for one having a larger memory space, e.g., memory 717 is larger than memory 718, the trainer with higher memory, e.g., trainer 711, may have a larger maximal micro batch size when receiving an identical mini-task.

In another example, in case two trainers, e.g., trainers 711 and 713, have identical specifications and are training identical mini-tasks, the maximal micro batch size of the at least one processor of the trainer with a higher micro batch size change rate (e.g., trainer 711) may be reduced compared to the at least one processor of a trainer with a lower micro batch size change rate (e.g., trainer 713).

According to embodiments of the invention, assigning each of mini-tasks 701, 702 and 703 to one of trainers 711, 713 and 715 may be performed based on the available computing power and/or other performance indicators at the trainers, including the respective maximal micro-batch size of the at least one processor of each one of the trainers 711, 713 and 715, the SLA, the SLO, the respective trainer's hardware, the communication speed and bandwidth available to each of the respective trainers, 711, 713 and 715, and other parameters. This point is demonstrated in the following paragraphs (the demonstration is simplified by assuming that each trainer comprises only a single processor).

Using micro-batches may require more iterations, comparing to processing of a mini-task in a single run with the original mini-batch size, leading to slower training. Accordingly, a mini-task may be assigned to trainers with a maximal micro-batch size that is closest to the original mini-batch size, either from above, if possible, e.g., in case the mini-batch size is equal to or smaller than the maximal micro-batch size, or from below, e.g., in case the mini-batch size is larger than the maximal micro-batch size.

For example: consider a case in which the mini-task comprises a mini-batch size of 32, the SLO is to train the mini task as fast as possible, and orchestrator 120 has only two trainers available, both with maximal micro-batch size that is higher than the mini-batch size of the mini-task, e.g., 128 and 64 respectively. In this case, the size of the mini-batch of the mini-task is smaller than the maximal micro-batch-size of both trainers, and gradient accumulation is not required. Thus, orchestrator 120 may choose to assign the mini-task to one of the available trainers based on various considerations. For example, orchestrator 120 may choose to assign the mini-task to the trainer with the smaller maximal micro-batch-size, so as to keep the trainer with the higher maximal micro-batch-size available for other mini-tasks that may potentially be sent by client 110.

However, if both trainers available (for the same mini-task and SLO) have a maximal micro-batch size that is smaller than the mini-batch size of the mini-task, e.g., 8 and 16 respectively, both trainers may require gradient accumulation in order to train the mini-task. The trainer with the higher maximal micro-batch size, however, may require fewer computing iterations compared with the trainer with the lower maximal micro-batch size, and thus may complete training the mini-task faster than the trainer with the lower maximal micro-batch size. Therefore, orchestrator 120 may assign the mini-task to the faster trainer with the higher maximal micro-batch size.

As another example, consider a case with the same mini-task as above, a SLO that is agnostic to the speed of training of the mini-task, a first trainer with maximal micro-batch size that is larger than the mini-batch size and a second trainer with a maximal micro-batch size that is smaller than the mini-batch size. In this case, since the the speed of training of the mini-task is not important, orchestrator 120 may choose to assign the mini-task to the trainer with the smaller maximal micro-batch-size, despite that fact the it may require more iterations and take more time, so as to keep the faster trainer with the higher maximal micro-batch-size available for other mini-tasks that may potentially be sent by client 110. Other considerations and prioritization may be used.

According to embodiments of the invention, orchestrator 120 may assign the mini-task, e.g., mini-task 701 to at least one designated trainer, e.g., trainer 711 of the plurality of trainers 711, 713 and 715, based on the maximal micro-batch size of at least one processor of trainer 711, the at least one mini-batch size 721 of the mini-task 701 and possibly other considerations, e.g., the SLO. For example, if one or more trainers of the the plurality of trainers 711, 713 and 715 has a maximal micro-batch size that is not smaller than the mini-batch size, orchestrator 120 may assign mini-task 701 to that one of those trainers. If, however, each of trainers 711, 713 and 715 has a maximal micro-batch size that is smaller than the mini-batch size, orchestrator 120 may apply gradient accumulation and instruct at least one of trainer trainers 711, 713 and 715 to calculate gradients of micro-batches in a size that is smaller than the maximal micro-batch size of trainer 711, and accumulate those gradients over the mini-batch, as disclosed herein.

For example, in case only a single trainer, e.g., trainer 711, has available computing power, if the at least one mini-batch size 721 of mini-task 701 is smaller than or equal to the maximal micro-batch size of trainer 711, then orchestrator 120 may assign mini-task 701 to trainer 711 as-is, e.g., orchestrator 120 may instruct trainer 711 to execute mini-task 701 with the original mini-batch size 721. If, however, the mini-batch size 721 of mini-task 701 is larger than the maximal micro-batch size, then orchestrator 120 may instruct trainer 711 to calculate gradients of micro-batches 731 in a size that is smaller than the maximal micro-batch size of trainer 711, and accumulate those gradients over the mini-batch, as disclosed herein. According to some embodiments, orchestrator 120 may transfer that entire mini-task 701 to trainer 711.

According to embodiments of the invention, each of trainers 711, 713 and 715 may include more than one processor, similarly to trainer 911 presented in FIG. 9. In such embodiments of the invention, the maximal micro-batch size of the trainer (e.g., trainer 911) may be calculated by orchestrator 120 to at least one of processors 912, 913 and 914 of trainer 911, or orchestrator 120 may allow trainer 911 to calculate the maximum micro-batch size for each processor 912, 913 and 914 of trainer 911, depending on the available memory 915, 916 and 917 of each processor 912, 913 and 914, respectively, and ensuring that the micro-batch size fits within the available memory of at least one of the processors 912, 913 and 914 (e.g., GPUs). Each micro-batch may be processed by at least one of separate processors 912, 913 and 914 (e.g., GPUs), and the gradients from each micro-batch may be accumulated by trainer 911 across at least one of the processors 912, 913 and 914 (e.g., GPUs) in trainer 911 as described above. This process may continue until trainer 911 may have completed training the mini-task.

According to embodiments of the invention, dividing a mini-task 701 to a plurality of mini-task portions 801, 802 and 803, and assigning each mini-task portion 801, 802 and 803 to a different processor 712, 714 and 714 in different trainers 711, 713 and 715, or to different processors 912, 913 and 914 in a single trainer, or any combination thereof, may expedite execution of mini-task 701 since it enables executing a single mini-task 701 on a plurality of processors in parallel, instead of a single processor per mini-task 701 as performed in the prior art.

According to embodiments of the invention, the maximal micro-batch size calculated or estimated by orchestrator 120 to each of trainers 711, 713 and 715 or to at least one of the processors therein, may be changed dynamically during training by the trainer to accommodate for changes in the performance parameters, during training, in any of the trainer's components, e.g., available memory space, input and output (I/O) calls or processor utilization. For example, each of trainers 711, 713 and 715 may periodically monitor the performance indicator of itself, or orchestrator 120 may periodically monitor the performance indicator of one or more of trainers 711, 713 and 715 to obtain a current performance indicator of trainers 711, 713 and 715. Each of trainers 711, 713 and 715 may dynamically adjust the size of the micro-batch 731, 732 and 733 processed by itself, or orchestrator 120 may dynamically adjust the size of the micro-batch 731, 732 and 733 assigned to one or more of trainers 711, 713 and 715 based on the current performance indicator of that trainer. According to embodiments of the invention, the maximum micro-batch size may be a function of a variety of factors, that together may impact the total computing and time resources required for training the mini-task 721, 722 and 723. In some cases, when a performance indicator such as processor utilization is increasing, the size of the micro-batch 731, 732 and 733 of the at least one processor of a trainer may decrease, and vice versa; If processor utilization is decreasing, the size of the micro-batch 731, 732 and 733 of the trainer may increase. Similarly, when a performance indicator such as input and output (I/O) speed is increasing, the micro-batch size of the trainer may increase, and vice versa; If I/O speed is decreasing, the micro-batch size of the at least one processor of the trainer may decrease. It should be readily understood that the dynamic adjustments of the size of the micro-batch 731, 732 and 733 apply to trainers with multiple processors, and to the embodiments of FIGS. 8-11 as well.

In some embodiments of the invention, trainer 711 may calculate gradients of micro-batches according to the at least one mini-task 701 assigned to trainer 711, and may accumulate the gradients over the at least one entire mini-batch. Once finished, trainer 711 may return the calculated gradients or the weights of the model trained upon the at least one mini-batch to orchestrator 120 that may update the weights of the ML model. Training may continue by generating new mini-tasks with the updated model weights and relevant datasets and hyperparameters.

Similar process may be performed for other mini-tasks and trainers, e.g., for mini-task 702 and trainer 713 and for mini-task 703 and trainer 716. While in system 760 each of trainers 711, 713 and 715 depicts a single processor 712, 714 and 716, trainers 711, 713 and 715 may include more than one processor.

Reference is now made to FIG. 8 which is a schematic illustration of a system 800 for providing decentralized computing resources, according to embodiments of the invention. Embodiments of system 800 may be similar to embodiments presented in FIGS. 1-4 and 7, with added functionally as disclosed infra. Similar components may have the same reference numerals and may not be explained again.

According to embodiments of the invention, orchestrator 120 may divide the mini-task 701 into a plurality of mini-task portions 801, 802 and 803, and assign each of mini-task portions 801, 802 and 803 to a respective designated trainer 711, 713 and 715, where each of mini-task portions 801, 802 and 803 may include a micro-batch size 821, 822 and 823, respectively, that is not larger than the maximal micro-batch size of the respective designated trainer. Orchestrator 120 may assign each of mini-task portions 801, 802 and 803 to a respective designated trainer 711, 713 and 715 by instructing the respective designated trainer 711, 713 and 715 to calculate gradients using gradient accumulation with the respective micro-batch size 821, 822 and 823. As used herein dividing a mini-task 701 into a plurality of mini-task portions 801, 802 and 803, may include logically dividing mini-task 701 (that has a predefined size of a mini-batch associated with it), to mini-task portions 801, 802 and 803 that are each associated with a micro-batch size 821, 822 and 823, respectively. The micro-batch sizes 821, 822 and 823 are each smaller than the predefined size of a mini-batch and define a size of a micro-batch that should be processed when performing each of the mini-task portions 801, 802 and 803. When added together, the micro-batches together the mini-batch.

Each of trainers 711, 713 and 715 may calculate gradients using gradient accumulation with the respective micro-batch size 821, 822 and 823 assigned to the trainers and provide the gradients to orchestrator 120. Once orchestrator 120 obtains all the gradients calculated by trainers 711, 713 and 715 for a complete mini-batch, orchestrator 120 may accumulate the gradients over the mini-batch, update the model weights and return the updated model to trainers 711, 713 and 715. Alternatively, once orchestrator 120 obtains all the gradients calculated by trainers 711, 713 and 715 for a complete mini-batch, orchestrator 120 may accumulate the gradients over the mini-batch, and transmit them to trainers 711, 713 and 715, wherein each shall update the model weights upon the gradients received from the orchestrator. After receiving the updated model from the orchestrator, or performing the update of model weights themselves, trainers 711, 713 and 715 shall proceed to the next micro-batch belonging to the next mini-batch. The process described shall be repeated until the training of mini-task portions 801, 802 and 803 is completed.

Reference is now made to FIG. 9 which is a schematic illustration of a system 900 for providing decentralized computing resources, according to embodiments of the invention. Embodiments of system 900 may be similar to embodiments presented in FIGS. 1-4, with added functionally as disclosed infra. Similar components may have the same reference numerals and may not be explained again. System 900 may include trainer 911 that may be or may include a computing device such as computing device 700 depicted in FIG. 13. Trainer 911 may be similar to trainers 130, 132 and 134 and may or may not include an RRE (not shown).

According to embodiments of the invention, trainer 911 may include a plurality of processors, e.g., processors 912, 913 and 914. Trainer 911 may obtain mini-task 701 or mini-task portion 801. Trainer 911 may obtain an estimation of a performance indicator in each of processors 912, 913 and 914, and may determine or calculate a maximal micro-batch size for each of processors 912, 913 and 914 based on the performance indicator of the respective processor, and parameters of mini-task 701 or mini-task portion 801, e.g., using equation 1. Other methods maybe used. Trainer 911 may divide (e.g., logically) mini-task 701 or mini-task portion 801 into a plurality of second-level mini-tasks 901, 902 and 903, and may assign each of the second-level mini-tasks 901, 902 and 903 to a respective processor of the plurality of processors 912, 913 and 914. According to embodiments of the invention, second-level mini-tasks 901, 902 and 903 may include a micro-batch size 921, 922 and 923, respectively, that is not larger than the maximal micro-batch size of the respective processor,

Trainer 911 may assign each of the second-level mini-tasks 901, 902 and 903 to the respective processor by instructing the respective processor to calculate gradients using gradient accumulation with micro-batches that have a size that equals the micro-batch size 921, 922 and 923.

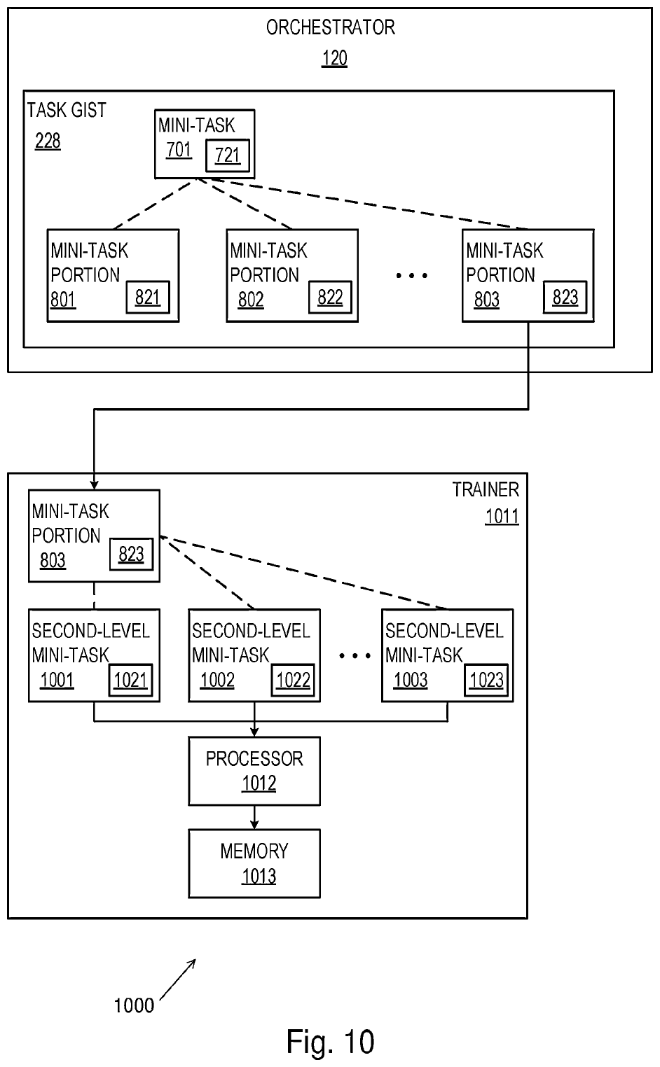

Reference is now made to FIG. 10 which is a schematic illustration of a system 1000 for providing decentralized computing resources, according to embodiments of the invention. Embodiments of system 1000 may be similar to embodiments presented in FIGS. 1-4, with added functionally as disclosed infra. Similar components may have the same reference numerals and may not be explained again. System 1000 may include trainer 1011 that may be or may include a computing device such as computing device 700 depicted in FIG. 13. Trainer 1011 may be similar to trainers 130, 132 and 134, may include a single processor, and may or may not include an RRE (not shown).

Trainer 1011 may obtain mini-task 701 or mini-task portion 803 and may monitor at least one current performance indicator of trainer 1011. Trainer 1011 may determine a new maximal micro-batch size for trainer 1011 based on the at least one current performance indicator, and parameters of mini-task 701 or mini-task portion 803, for example using equation 1. Other methods may be used. Trainer 1011 may logically divide mini-task 701 or mini-task portion 803 to a plurality of second-level mini-tasks 1001, 1002 and 1003, where each of second-level mini-tasks 1001, 1002 and 1003 may have a micro-batch size 1021, 1022 and 1023, respectively, that is not larger than the new maximal micro-batch size. Processor 1012 associated with memory 1013, of trainer 1011 may execute the of second-level mini-tasks 1001, 1002 and 1003 by calculating gradients using gradient accumulation and with micro-batches that have a size that equals the new micro-batch size 1021, 1022 and 1023.

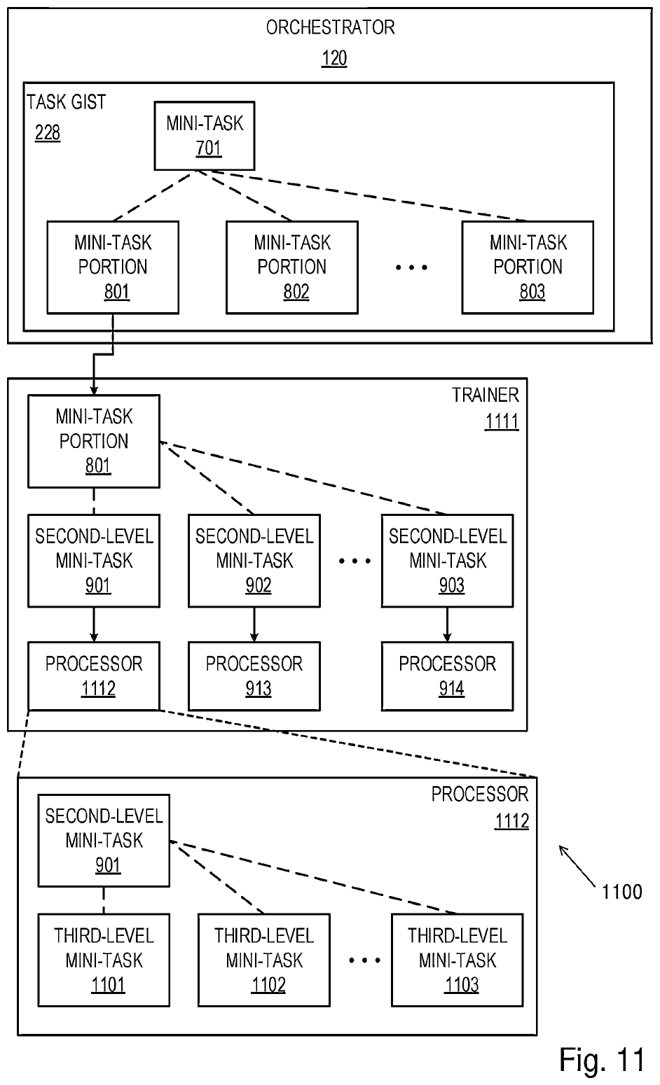

Reference is now made to FIG. 11 which is a schematic illustration of a system 1100 for providing decentralized computing resources, according to embodiments of the invention. Embodiments of system 1100 may be similar to embodiments presented in FIGS. 1-4 and may include a combination of the functionality of FIGS. 7-10 as disclosed infra. Similar components may have the same reference numerals and may not be explained again. System 1100 may include trainer 1011 that may be or may include a computing device such as computing device 700 depicted in FIG. 13. Trainer 1011 may be similar to trainers 130, 132 and 134, may include a single processor, and may or may not include an RRE (not shown).

System 1100 demonstrate a combination of three levels of dividing mini-task 701. In a first level mini-task 701 may be divided to a plurality of mini-task portions 801, 802 and 803, in a second level one of the mini-task portions 801 may be further divided to a plurality of second level mini-tasks 901, 902 and 903, and in a third level one of second level mini-tasks 901 may be divided to third level mini-tasks 1101, 1102 and 1103.

Specifically, orchestrator 120 may divide mini-task 701 to a plurality of mini-task portions 801, 802 and 803, and assign each of the task portions 801, 802 and 803 to a designated trainer, of which only trainer 1111 is shown, similarly to the embodiments of systems 800 and 900. Trainer 1111 may include a plurality of processors 1112, 913 and 914 and may further divide mini-task portion 801 to a plurality of second level mini-tasks 901, 902 and 903, similarly to the embodiment of system 900. Processor 1112 may divide second level mini-task 901 to a plurality of third level mini-tasks 1101, 1102 and 1103, similarly to the embodiments of system 1000. Each level may be ignorant to the further divisions performed at the next levels, e.g., orchestrator 120 may not be aware that trainer 1111 further divides mini-task portion 801, and both orchestrator 120 and trainer 1111 may not be aware that processor 1112 further divides second level mini-task 901. Each level may calculate gradients and return the calculated gradient's to the level above.

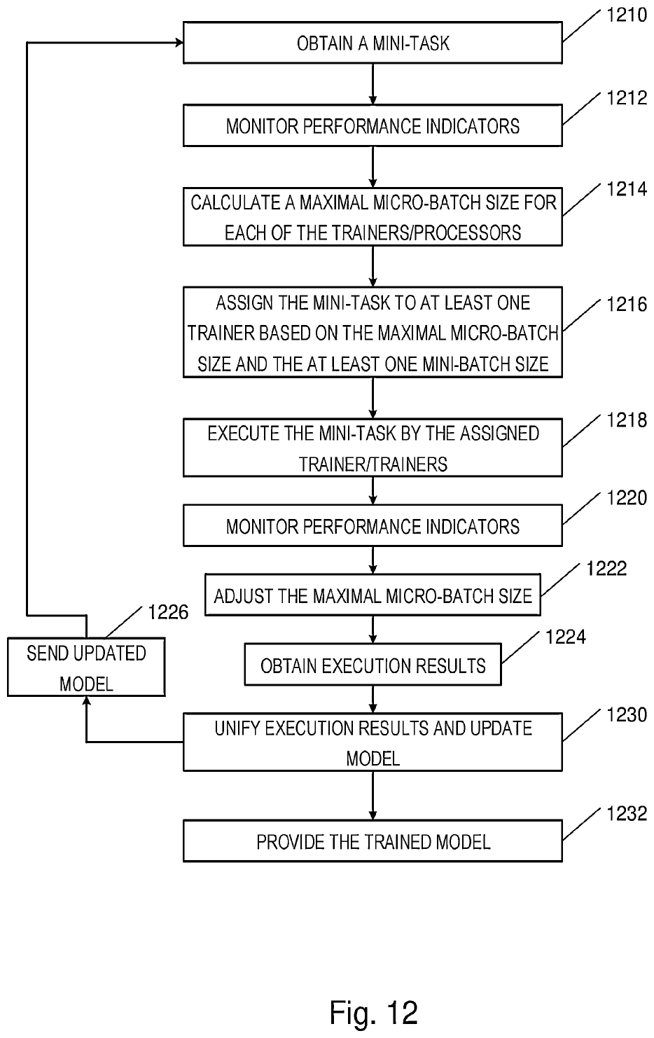

Reference is now made to FIG. 12, which is a flowchart of a method for using gradient accumulation in system for training an ML model using decentralized computing resources, according to some embodiments of the present invention. While in some embodiments the operations of FIG. 12 are carried out using systems as shown in FIGS. 1, 2, 7-11 and 13, in other embodiments other systems and equipment can be used. For example, operations below may be performed by orchestrator 120 and/or trainers 130, 132 and 134, depicted in FIG. 1, and any of the trainers depicted in FIGS. 7-11. In some embodiments some of the operations are performed by orchestrator 120, while other operations are performed by the trainers. Embodiments of the method for providing decentralized computing resources for training an ML model presented in FIG. 12 may be a variant of the embodiments presented in FIG. 5 with the added functionality of implementing gradient accumulation. However, in some embodiments translating a task of training an ML model may not be needed, as disclosed herein.

In operation 1210, a processor (e.g., processor 705 depicted in FIG. 13) may obtain a mini-task of training an ML model. The mini-task may include, inter alia, at least one mini-batch size. According to some embodiments, the mini-task may include a portion of a task, a translated task or a task gist disclosed herein. For example, in some embodiments, orchestrator 120 may obtain a task 210, e.g., from a client such as client 110 or from another source, extract a task gist 228, and generate a translated task 226 as disclosed herein. Orchestrator 120 may further divide or partition task gist 228 of the translated task 226 into portions or mini-tasks (e.g., such as mini-tasks 701, 702 and 703). In some embodiments, orchestrator 120 may divide or partition the task (without translating or extracting the task gist) into mini-tasks. While a task gist, task and translated task may each include the model structure, model weights, datasets, and hyperparameters, a mini-task may include the model structure, the model weights, the datasets, and a subset of the hyperparameters that includes at least one mini-batch size. As noted, a mini-task may include more than one mini-batch sizes, still the explanation below will be given for a single mini-batch size for clarity. If a mini-task includes more than one mini-batch sizes, the process below is similar for each mini-batch size.

In operation 1212, the processor may monitor or obtain an estimation of a performance indicator in each trainer of a plurality of trainers that have available computing power. In some embodiments were a trainer includes more than one processor, estimation of a performance indicator may be obtained for each processor in the trainer or for the trainer as a whole. The performance indicator may include one or more of the free or available computing power and the free or available memory space. In some embodiments, one ore more other performance indicators such as frequency of past dynamic adjustments of the size of the micro-batch designated or assigned to the trainer, the specifications of the processor, performance statistics of trainer such as a sample processing rate, etc., may be monitored as well.

In operation 1214, the processor may estimate, calculate or determine a maximal micro-batch size for each of the plurality of trainers, or for each of the processors of each trainer, based on a performance indicator of the trainers or processors, and performance parameters of the mini-task, for example, using Equation 1. Alternative or additional performance indicators may be used to adjust the maximal micro-batch size, as disclosed herein.

In operation 1216, the processor may automatically assign the mini-task to at least one designated trainer of the plurality of trainers based on the maximal micro-batch size and the at least one mini-batch size. For example, the processor may assign the mini-task to a trainer with a maximal micro-batch size that is larger than the mini-batch size, if such a trainer is found. If such a trainer is not found, e.g., if the maximal micro-batch size of all the trainers is smaller than the mini-batch size, then the processor may apply gradient accumulation by logically dividing the mini-task (that has a mini-batch size associated with it) into a plurality of mini-task portions, each including a micro-batch size that is smaller then the mini-batch size and not larger (e.g., equals or smaller) than the maximal micro-batch size of the respective designated trainer, and assign each mini-task portion to a respective trainer.

According to embodiments of the invention, assigning the mini-task or the mini-task portion to the at least one designated trainer may include instructing each designated trainer to calculate gradients using mini-batches or micro-batches in a size that is not larger than the maximal micro-batch size of the respective designated trainer.

In operation 1218, the one or more assigned or designated trainers may execute the mini-task, or the mini-task portion assigned to them, e.g., the trainers may calculate gradients based on the samples included in the mini-batch or micro-batch, using the model weights structure and other hyperparameters included in the mini-task.

In operation 1220, the one or more performance indicators of the one or more trainers or the one or more processors in the trainers may be monitored, while performing the mini-task or the mini-task portion, to obtain one or more current performance indicators. For example, some or all of the performance indicators monitored in operation 1212 may be monitored, and a current performance indicator may be calculated for the one or more trainers, or for the one or more processors in the trainers. In operation 1222, the maximal micro-batch size of trainers or processors used may be adjusted dynamically, e.g., while executing the mini-task, based on the current performance indicators. Adjusting the maximal micro-batch size may imply adjusting the size of a micro-batch used for training, e.g., updating the division of the mini-task to mini-task portions having a new micro-batch size.

For example, the processor may obtain a change in the estimation of the available memory space in one of the designated trainers, and dynamically adjust the size of the micro-batch of that trainer based on the currently available memory space. According to some embodiments, in operation 1220, the processor may periodically monitor the execution time of running the mini-batch through the ML model at one of the designated trainers, and in operation 1222, the processor may dynamically adjust the size of the micro-batch designated to that trainer based on the execution time.

According to some embodiments, in operation 1222, in addition or instead of updating the micro-batch size, gradient checkpointing may be applied at a designated trainer based on the current performance indicator. Gradient checkpointing is a method used for saving memory while training an ML model, in the cost of performing more calculations. In many cases, what consumes the most memory is not the model itself but the intermediate activations (e.g., intermediate calculation results performed during forward propagation and later used for calculating the gradients during back propagation). While calculating each batch in forward propagation, these activations may be calculated and saved to memory. Then, in the process of back-propagation, the intermediate activations may be taken from the memory and used for calculating gradients, that are used for calculating the model weights. Once weights are updated, all activations and gradients may be disposed of memory. Gradient checkpointing may reduce the amount of memory consumed for storing the intermediate activations, by only storing a subset of the intermediate activations instead of all the intermediate outputs. As a consequence, the intermediate activations that are not stored must be recomputed during the backward pass. Therefore, checkpointing may increase the amount of computation; however, checkpointing has no effect on the accuracy of calculating the gradients and weights as the training procedure is numerically unchanged. To summarize, when implementing gradient checkpointing, instead of storing all intermediate activations, only part of the intermediate activations is stored. When the intermediate activations are needed (during backpropagation), the intermediate activations are computed again. The application of this technique saves a significant amount of expensive memory, at a relatively low cost of additional computation and time.

According to embodiments of the invention, the performance indicators of trainers and processors e.g., the available memory, may change over time, for example, if the trainer is used for executing another task in parallel. Thus, applying gradient checkpointing technique may be required during those periods of time, when certain performance indicators decrease, e.g., when the available memory space is insufficient.

In operation 1224, the designated one or more trainers may perform the training, e.g., calculate gradients using the mini-batch or micro-batch, and send the execution results. The processor may obtain the execution results, e.g., the calculated gradients. In operation 1230, the processor may unify, accumulate or average the calculation results, e.g., the calculated gradients. This operation may not be required if gradient accumulation is not used. However, if gradient accumulation is used, then in operation 1224, the processor may obtain the gradients calculated for the plurality of micro-batches, and in operation 1230 the processor may unify, e.g., accumulate or average the gradients to obtain the final gradients of the mini-batch. The processor may update the model weights using the final gradients to calculate the updated model. In operation 1126, the processor may send, transmit or provide the updated model back to the trainer or trainers, so that the next iteration of training with a new mini-batch may be performed with the updated model. In operation 1232, the trained model, e.g., the model weights and structure after executing the entire training, may be provided, e.g., ro client 110 or to a system administrator.

FIG. 13 illustrates an example computing device according to an embodiment of the invention. Various components such as clients 110, 112, 114 orchestrator 120 and trainers 130, 132 and 134 may be or include computing device 700, or may include components such as shown in FIG. 13. For example, a first computing device 700 with a processor 705 may be used to translate a computing task and distribute the translated task among trainers 130, 132 and 134.

Computing device 700 may include one or more processors 705 that may be, for example, a CPU, a GPU, a TPU, a DSP, a chip, an field-programmable gate array (FPGA), an Application Specific Integrated Circuit (ASIC), a system on a chip (SoC), or any suitable computing or computational device, an operating system 715, a main memory 720, a storage 730, input devices 735 and output devices 740. Processor 705 may be or include one or more processors, etc., co-located or distributed. Processor 705 (e.g. GPU) may include processor memory 706. Computing device 700 may be for example a workstation, personal computer, media streaming device, smart TV, smart phone, tablet, set top box, gaming console, car infotainment system or may be at least partially implemented by a remote server (e.g., in the “cloud”).

Operating system 715 may be or may include any code segment designed and/or configured to perform tasks involving coordination, scheduling, arbitration, supervising, controlling or otherwise managing operation of computing device 700, for example. Operating system 715 may be a commercial operating system. Main memory 720 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Main memory 720 may be or may include a plurality of, possibly different memory units. Processor memory 706 may be or may include, for example, a Video Random Access Memory (VRAM), High Bandwidth Memory (HBM), Static Random Access Memory (SRAM), on chip memory integrated directly to the processor, shared system memory, Flash memory, a volatile memory, a non-volatile memory, a cache memory, a buffer, a short term memory unit, a long term memory unit, or other suitable memory units or storage units. Processor memory 706 may be or may include a plurality of, possibly different memory units. Each of memory modules 717, 718, 719, 915, 916, 917 and 1013 may be or may include processor memory 706.

Executable code 725 may be any executable code, e.g., an application, a program, a process, task or script. Executable code 725 may be executed by processor 705 possibly under control of operating system 715. For example, executable code 725 may be or include code applicable for translating a computing task and distributing the translated task among trainers 130, 132 and 134. As another example executable code 725 may be or include code applicable for converting the translated task results received back from trainers 130, 132 and 134, or from parameter server 150, to a programming language or format required by client 110. In some embodiments, more than one computing device 700 may be used. For example, a plurality of computing devices that include components similar to those included in computing device 700 may be connected to a network and used as a system.

Storage 730 may be or may include, for example, a hard disk drive, a floppy disk drive, a Compact Disk (CD) drive, a CD-Recordable (CD-R) drive, a universal serial bus (USB) device or other suitable removable and/or fixed storage unit. In some embodiments, some of the components shown in FIG. 13 may be omitted. For example, main memory 720 may be a non-volatile memory having the storage capacity of storage 730. Accordingly, although shown as a separate component, storage 730 may be embedded or included in main memory 720.

Input devices 735 may be or may include a mouse, a keyboard, a touch screen or pad or any suitable input device. It will be recognized that any suitable number of input devices may be operatively connected to computing device 700 as shown by block 735. Output devices 740 may include one or more displays, speakers and/or any other suitable output devices. It will be recognized that any suitable number of output devices may be operatively connected to computing device 700 as shown by block 740. Any applicable input/output (I/O) devices may be connected to computing device 700 as shown by blocks 735 and 740. For example, a wired or wireless network interface card (NIC), a modem, printer or facsimile machine, a universal serial bus (USB) device or external hard drive may be included in input devices 735 and/or output devices 740. Network interface 750 may enable device 700 to communicate with one or more other computers or networks. For example, network interface 750 may include a WiFi or Bluetooth device or connection, a connection to an intranet or the internet, an antenna etc.

Embodiments described in this disclosure may include the use of a special purpose or general-purpose computer including various computer hardware or software modules, as discussed in greater detail below.

Embodiments within the scope of this disclosure also include computer-readable media, or non-transitory computer storage medium, for carrying or having computer-executable instructions or data structures stored thereon. The instructions when executed may cause the processor to carry out embodiments of the invention. Such computer-readable media, or computer storage medium, can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computer” may be any computing system as previously defined herein, or any module or combination of modulates running on a computing system or combining together to operate as a computer system.

Computer database, systems integration, and scheduling technology may be improved by shortening the time taken to identify a person, retrieve records related to the person, and schedule a meeting with the person.

For the processes and/or methods disclosed, the functions performed in the processes and methods may be implemented in differing order as may be indicated by context. Furthermore, the outlined steps and operations are only provided as examples, and some of the steps and operations may be optional, combined into fewer steps and operations, or expanded into additional steps and operations.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “network”, “processing,” “computing,” “calculating,” “mesh”, “determining,” “transfer”, “establish”, “analyzing”, “checking”, or the like, can refer to operation(s) and/or process(es) of a computer, a computing platform, a computing system, or other electronic computing device, or related network thereof, that manipulate and/or transforms data represented as physical (e.g., electronic) quantities within the computers' registers and/or memories into other data similarly represented as physical quantities within computers' registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A method for decentralized training of a machine learning model, the method comprising, using a main processor:
obtaining a mini-task of training the machine learning model wherein the mini-task comprises at least one mini-batch size;
obtaining an estimation of at least one performance indicator in each trainer of a plurality of trainers that have available computing power, wherein each trainer comprises one or more processors;
calculating a maximal micro-batch size for each processor of the plurality of trainers based on the at least one performance indicator of the respective trainer, and parameters of the mini-task; and
assigning the mini-task to at least one designated trainer of the plurality of trainers based on the maximal micro-batch sizes of the one or more processors of the at least one designated trainer and the at least one mini-batch size.

2. The method of claim 1, wherein assigning the mini-task to the at least one designated trainer comprises instructing each designated trainer of the at least one designated trainers to calculate model weights using mini-batches or gradients using micro-batches.

3. The method of claim 1, wherein assigning the mini-task to the at least one designated trainer comprises logically dividing the mini-task into a plurality of mini-task portions, and assigning each mini-task portion of the plurality of mini-task portions to a respective designated trainer of the plurality of designated trainers, wherein each mini-task portion of the plurality of mini-task portions comprises a micro-batch size that is not larger than the maximal micro-batch size of the respective one or more processors of the designated trainer,
wherein assigning a mini-task portion to a respective designated trainer comprises instructing the respective designated trainer to calculate gradients with the respective micro-batch size.

4. The method of claim 3, comprising:
obtaining gradients calculated by each of the at least one designated trainer;
accumulating the gradients over the mini-batch; and
updating weights of the machine learning model using the gradients.

5. The method of claim 1, comprising:
assigning the mini-task or mini-task portion to a first designated trainer of the at least one designated trainer,-wherein the first designated trainer comprises a plurality of processors;
logically dividing the mini-task or mini-task portion into a plurality of second-level mini-tasks and assigning each of the second-level mini-tasks to a respective processor of the plurality of processors, wherein each second-level mini-task of the plurality of second-level mini-tasks comprises a micro-batch size that is not larger than the maximal micro-batch size of the respective processor,
wherein assigning each of the second-level mini-tasks to the respective processor comprises instructing the respective processor to calculate gradients with micro-batches that have a size that equals the micro-batch size.

6. The method of claim 1, comprising:
obtaining the mini-task or mini-task portion to a first designated trainer of the at least one designated trainer;
monitoring, by the first designated trainer, at least one current performance indicator of the first designated trainer;
determining a new maximal micro-batch size for the first designated trainer based on the at least one current performance indicator, and parameters of the mini-task or mini-task portion;
logically dividing, by the first designated trainer, the mini-task or mini-task portion to a plurality of second-level mini-tasks, wherein each second-level mini-task of the plurality of second-level mini-tasks has a micro-batch size that is not larger than the new maximal micro-batch size; and
executing the of second-level mini-tasks by calculating gradients with micro-batches that have a size that equals the new micro-batch size.

7. The method of claim 6, comprising:
obtaining a reduction in the performance indicator in the first designated trainer, wherein the reduction makes the designated trainer uncapable for executing the second-level mini-task;
and
applying a gradient checkpointing in the first designated trainer.

8. The method of claim 1, wherein the performance indicators of a trainer comprise at least one of the list consisting of: available memory space of each processor in the trainer, computing power of each processor in the trainer, total memory space of the processors in the trainer, frequency of past dynamic adjustments of the size of the micro-batch assigned to the trainer, specifications of each processor of the trainer and sample processing rate of each processor in the trainer, and wherein the parameters of the task comprise memory space required for training the machine learning model and memory space required for training a sample of the plurality of samples.

9. The method of claim 1, comprising:
periodically monitoring the performance indicator of a first designated trainer of the at least one designated trainer to obtain a current performance indicator of the first designated trainer; and
dynamically adjusting the size of the micro-batch assigned to the first designated trainer based on the current performance indicator.

10. The method of claim 9, comprising:
obtaining a frequency of past dynamic adjustments of the size of the maximal micro-batch designated to the first designated trainer;
wherein the mini-task is assigned to the at least one designated trainer based on the frequency of past dynamic adjustments.

11. The method of claim 1, comprising:
periodically monitoring a sample processing rate at a first designated trainer of the at least one designated trainer; and
dynamically adjusting the size of the micro-batch designated to the first trainer based on the sample processing rate.

12. The method of claim 1, comprising:
obtaining a change in the estimation of an available memory space in a first designated trainer of the at least one designated trainer; and
dynamically adjusting the maximal micro-batch size of the first designated trainer based on the estimation of the available memory space.

13. The method of claim 1, wherein the mini-task comprises a portion of a task gist extracted from a task of training of a machine learning model, wherein the task gist comprises a model structure, model weights, datasets, and hyperparameters, and wherein the portion comprises the model structure, the model weights, the datasets, and a subset of the hyperparameters, and wherein assigning the mini-task to the at least one designated trainer comprises transferring the mini-task to the at least one designated trainer.

14. The method of claim 1, wherein the machine learning model is a neural network.

15. The method of claim 1, wherein the mini-task of training of the machine learning model comprises the model weights, hyperparameters and datasets.

16. A system for performing decentralized training of a machine learning model, the system comprising:
a main memory; and
a main processor configured to:
obtain a mini-task of training the machine learning model wherein the mini-task comprises at least one mini-batch size;
obtain an estimation of at least one performance indicator in each trainer of a plurality of trainers that have available computing power, wherein each trainer comprises one or more processors;
calculate a maximal micro-batch size for each processor of the plurality of trainers based on the at least one performance indicator of the respective trainer, and parameters of the mini-task; and
assign the mini-task to at least one designated trainer of the plurality of trainers based on the maximal micro-batch sizes of the one or more processors of the at least one designated trainer and the at least one mini-batch size.

17. The system of claim 16, wherein the main processor is configured to assign the mini-task to the at least one designated trainer by instructing each designated trainer of the at least one designated trainers to calculate model weights using mini-batches or gradients using micro-batches.

18. The system of claim 16, wherein the main processor is configured to assign the mini-task to the at least one designated trainer by logically dividing the mini-task into a plurality of mini-task portions, and assigning each mini-task portion of the plurality of mini-task portions to a respective designated trainer of the plurality of designated trainers, wherein each mini-task portion of the plurality of mini-task portions comprises a micro-batch size that is not larger than the maximal micro-batch size of the respective one or more processors of the designated trainer,
wherein the main processor is configured to assign a mini-task portion to a respective designated trainer by instructing the respective designated trainer to calculate gradients with the respective micro-batch size.

19. The system of claim 18, wherein the main processor is configured to:
obtain gradients calculated by each of the at least one designated trainer;
accumulate the gradients over the mini-batch; and
update weights of the machine learning model using the gradients.

20. The system of claim 16, wherein the main processor is configured to:
assign the mini-task or mini-task portion to a first designated trainer of the at least one designated trainer,-wherein the first designated trainer comprises a plurality of processors;
divide the mini-task or mini-task portion into a plurality of second-level mini-tasks and assign each of the second-level mini-tasks to a respective processor of the plurality of processors, wherein each second-level mini-task of the plurality of second-level mini-tasks comprises a micro-batch size that is not larger than the maximal micro-batch size of the respective processor,
wherein assigning each of the second-level mini-tasks to the respective processor comprises instructing the respective processor to calculate gradients with micro-batches that have a size that equals the micro-batch size.

21. The system of claim 16, comprising a first designated trainer, wherein the first designated trainer is configured to:
obtain the mini-task or mini-task portion;
monitor at least one current performance indicator of the first designated trainer;
determine a new maximal micro-batch size for the first designated trainer based on the at least one current performance indicator, and parameters of the mini-task or mini-task portion;
divide the mini-task or mini-task portion to a plurality of second-level mini-tasks, wherein each second-level mini-task of the plurality of second-level mini-tasks has a micro-batch size that is not larger than the new maximal micro-batch size; and
execute the of second-level mini-tasks by calculating gradients with micro-batches that have a size that equals the new micro-batch size.

22. The system of claim 21, wherein the main processor is configured to:
obtain a reduction in the performance indicator in the first designated trainer, wherein the reduction makes the designated trainer uncapable for executing the second-level mini-task;
and
apply a gradient checkpointing in the first designated trainer.

23. The system of claim 16, wherein the performance indicators of a trainer comprise at least one of the list consisting of: available memory space of each processor in the trainer, computing power of each processor in the trainer, total memory space of the processors in the trainer, frequency of past dynamic adjustments of the size of the micro-batch assigned to the trainer, specifications of each processor of the trainer and sample processing rate of each processor in the trainer, and wherein the parameters of the task comprise memory space required for training the machine learning model and memory space required for training a sample of the plurality of samples.

24. The system of claim 16, wherein the main processor is configured to:
periodically monitor the performance indicator of a first designated trainer of the at least one designated trainer to obtain a current performance indicator of the first designated trainer; and
dynamically adjust the size of the micro-batch assigned to the first designated trainer based on the current performance indicator.

25. The system of claim 16, wherein the main processor is configured to:
obtain a frequency of past dynamic adjustments of the size of the maximal micro-batch designated to the first designated trainer;
wherein the mini-task is assigned to the at least one designated trainer based on the frequency of past dynamic adjustments.

26. The system of claim 16, wherein the main processor is configured to:
periodically monitor a sample processing rate at a first designated trainer of the at least one designated trainer; and
dynamically adjust the size of the micro-batch designated to the first trainer based on the sample processing rate.

27. The system of claim 16, wherein the main processor is configured to:
obtain a change in the estimation of an available memory space in a first designated trainer of the at least one designated trainer; and
dynamically adjust the maximal micro-batch size of the first designated trainer based on the estimation of the available memory space.

28. The system of claim 16, wherein the mini-task comprises a portion of a task gist extracted from a task of training of a machine learning model, wherein the task gist comprises a model structure, model weights, datasets, and hyperparameters, and wherein the portion comprises the model structure, the model weights, the datasets, and a subset of the hyperparameters, and wherein assigning the mini-task to the at least one designated trainer comprises transferring the mini-task to the at least one designated trainer.

29. The system of claim 16, wherein the machine learning model is a neural network.

30. The system of claim 16, wherein the mini-task of training of the machine learning model comprises the model weights, hyperparameters and datasets.
